(19) United States
(12) Patent Application Publication
(10) Pub. No.: US 2002/0134281 A1
(43) Pub. Date: Sep. 26, 2002

(54) Process for the production of chemically or enzymatically modified polysaccharides, and products made thereby

(76) Inventors: Ronald Busink, Bennekom (NL); Alfred J. Haandrikman, Amersfoort (NL); Michaela Hofbauer, Roosendaal (NL); Hielke Tjeerd de Vries, Ede (NL); Sandra Berberich-Francken, Tilburg (NL)

Correspondence Address: Mr. Gary A. Samuels, Hercules Incorporated, Hercules Plaza, 1313 North Market Street, Wilmington, DE, 19894-0001, US

(21) Appl. No.: 09/920,122

(22) Filed: Aug. 1, 2001

Related U.S. Application Data
(60) Provisional application No. 60/222,730, filed on Aug. 3, 2000.

(51) Int. Cl. C09D 101/26

(52) U.S. Cl. 106/187.1; 106/205.7

(57) ABSTRACT

Processes for reducing viscosity in an aqueous polysaccahride composition comprising combining the aqueous composition with a non-aqueous viscosity reducing agent. In particular, processes for reducing the viscosity in an aqueous carbohydrate gum composition. In particular, processes for reducing viscosity of an aqueous composition of polysaccharide comprising combining viscosity reducing agent with the polysaccharide composition in an amount effective to form a two phase system. Products produced according to the aforementioned processes are also described. Aqueous compositions including polysaccharide and non-aqueous viscosity reducing agent, and wherein the water content of the composition is at least about 40 wt %. Aqueous compositions including polysaccharide and non-aqueous viscosity reducing agent and wherein the viscosity of the composition is reduced by at least 10%. Processes for resolubilizing solid oxidized carbohydrate gum comprising combining aqueous solvent with the oxidized carbohydrate gum under conditions effective to give a resolubilized composition a pH less than about 7.

### CROSS-REFERENCE TO RELATED APPLICATIONS

This application is related to U.S. Provisional Patent Application Serial No. 60/222,730, filed Aug. 3, 2000, from which priority is claimed.

### BACKGROUND OF THE INVENTION

1. Field of the Invention

The present invention is directed to processes for improving the manageability characteristics of water-soluble polymers, and more particularly, of carbohydrate gums, and even more particularly, of oxidized carbohydrate gums. In particular, the present invention is directed to processes for improving the mixing characteristics, such as, e.g., reducing the viscosity, of oxidized carbohydrate gum-containing aqueous mixtures. Processes in accordance with the present invention may be achieved by the addition of viscosity reducing agents. The present invention is also directed to processes for producing coacervates comprising carbohydrate gums and viscosity reducing agents. The present invention includes processes wherein oxidized carbohydrate gum is recovered from aqueous reaction mixtures containing polyethylene glycol. The processes of the present invention are directed to mixtures comprising oxidized carbohydrate gum in combination with polyethylene glycol.

2. Background of the Invention and Related Art

The commercial value of carbohydrate gums is well recognized. Guar gum, in particular, is useful in applications ranging from food and cosmetics to paper making. A general discussion of carbohydrate gums is presented in R. L. Whistler, J. N. BeMiller, (Eds.) Industrial gums: polysaccharides and their derivatives. 1993, Academic Press Inc. San Diego, Calif. 92101, the entire contents of which are hereby incorporated by reference as though set forth in full herein. Much of the usefulness of these carbohydrates derives from their ability to alter the flow properties of liquid systems. Modifying the rheological properties of carbohydrate gums can enhance their commercial applicability considerably. Modifications can be achieved by derivatizing functional groups. Guar gum and guar derivatives are commonly used in paper making to enhance the end product qualities of the paper product, including enhancing strength, including dry-strength. For their discussion of the use of guar in paper products, reference is made to U.S. Pat. Nos. 5,633,300, 5,502,091, 5,338,407, 5,318,669, to Dasgupta et al., all of which are hereby incorporated by reference. Oxidized cationic guar gum is particularly useful for applications in paper products. In this regard, reference is made to U.S. Pat. Nos. 5,554,745 and 5,700,917, both of which are hereby incorporated by reference.

Frollini et al. (Carbohydrate Polymers 27 (1995) 129-135) and M. J. Donnelly, Viscosity control of guar polysaccharide solutions by treatment with galactose oxidase and catalase enzymes. In: C. Burke (Ed.) Carbohydrate Biotechnology Protocols, 1999, Humana Press, Totowa (N.J.), pp.79 B 88 have shown that increasing the degree of oxidation of guar results in an increase in the viscosity of the oxidized guar. From an application standpoint, a high degree of oxidation is beneficial—the greater the oxidation of the guar, the less oxidized guar necessary to achieve the same effect. From a production standpoint, it is also highly beneficial to produce a dry product. Thus, an ideal oxidized guar product is one which is highly oxidized and dried.

However, those beneficial properties of oxidized guar could make it practically quite difficult to work with. For example, because oxidized guar is so highly viscous in aqueous solution, the actual process of producing the oxidized guar results in a highly viscous solution, which can be unmanageable. Additionally, once the oxidized guar is dried until it becomes substantially solid, it will be difficult to re-solubilize, without significantly affecting the molecular weight and the aldehyde content of the product. One way to deal with this problem would be to take the freshly oxidized carbohydrate gum reaction mixture and place it directly into whatever application is desired, thereby avoiding the drying/re-solubilizing problem. Obviously, however, this requires placing the oxidizing reactants, either chemicals or enzymes, into the application mixture as well. This is often environmentally undesirable because it exposes an application mixture, for example paper pulp, to unnecessary loading with chemicals or enzymes. Additionally, this choice is unappealing in its entirety because it requires working with dilute solutions of products, which are more costly to handle.

Alternatively, the viscosity problem could be overcome by considerably diluting the reaction mixture with water. However, this is not a real solution to the problem because the volumes required to decrease the viscosity to any meaningful extent render the process unworkable. Moreover, if the mixture is to be dried, the additional water would render the process more costly in the drying stage.

The present invention is directed to solving problems in the prior art. In particular, the present invention is useful where aldehyde groups are introduced into a polysaccharide during oxidation. For instance, it is well known that compositions comprising aldehyde-containing polymers, including aldehyde-containing polysaccharides, in aqueous solution tend to form crosslinks. During the course of the reaction, this will lead to a dramatic increase in viscosity of the reaction mixture, Frollini et al. (Carbohydrate Polymers 27 (1995) 129-135) and M. J. Donnelly, Viscosity control of guar polysaccharide solutions by treatment with galactose oxidase and catalase enzymes. In: C. Burke (Ed.), Carbohydrate Biotechnology Protocols, 1999, Humana Press, Totowa (N.J.), pp.79 B 88, which will make the mixture unmanageable at higher degrees of conversion. In the invention described here, this problem can be avoided through addition of a viscosity reducing agent, before, during, or after the oxidation reaction. A further disadvantage of the crosslinking reaction described above is the poor solubility of the crosslinked reaction products. This has been observed from many aldehyde containing polymers, especially aldehyde containing polysaccharides (Frollini et al., and references cited therein: Painter & Larsen, 1970; Mazur, 1991; Donnelly, 1999; and Bretting & Jacobs, 1987, the entire contents of each of which is hereby incorporated by reference). A measure known in the art for addressing this problem is the protection of the aldehyde group during storage of the product, for example in the form of an acetal, which then has to be hydrolyzed to the aldehyde directly before the product is used.

However, protection of the aldehyde group of a polysaccharide has the disadvantage that the deprotection usually requires relatively harsh reaction conditions, which affect the polymer backbone of the polysaccharide and thereby reduce the performance of the reaction product. This side effect is largely due to the fact that the polysaccharide backbone is built up by acetal-bond linked monosaccharides.

Thus, there is a need in the art for a solution to the problems created by oxidized carbohydrate gums, dry polysaccharides and modified polysaccharides, and low viscosity solutions with relatively high polysaccharide concentrations. The present invention solves the aforementioned problems without the side effects of prior art solutions to these problems.

### SUMMARY OF THE INVENTION

In view of the foregoing, one aspect of the present invention is directed to processes for decreasing the viscosity of aqueous mixtures containing polysaccharides, and more particularly oxidized carbohydrate gums. Products produced according to these processes are also contemplated.

The present invention is also directed to processes for decreasing the viscosity of aqueous mixtures containing polysaccharides, and more particularly oxidized carbohydrate gums, through the use of viscosity reducing agents. Products produced according to these processes are also contemplated.

The present invention is further directed to processes for producing oxidized carbohydrate gums. Products produced according to these processes are also contemplated. The present invention includes processes whereby aggregates of oxidized guar gum or aggregates of oxidized guar gum derivatives can be prepared, stored, and subsequently dissolved in water without significantly affecting the molecular weight and the aldehyde content of the product.

The present invention further provides processes whereby dried or solid oxidized guar gum or solid oxidized guar gum derivatives can be prepared, stored, and subsequently dissolved in water without significantly affecting the molecular weight and the aldehyde content of the product.

The present invention is also directed to processes for producing coacervates comprising polysaccharides or polysaccharide derivatives and viscosity reducing agents. Products produced according to these processes are also contemplated.

The present invention is still further directed to processes for using coacervates produced according to the present invention. Products produced according to these processes are also contemplated.

The present invention is further directed to processes of recovering oxidized carbohydrate gum, and more particularly, oxidized guar gum and/or oxidized guar gum derivatives, from aqueous reaction mixtures. Products produced according to these processes are also contemplated.

The present invention is more particularly directed to processes for recovering oxidized carbohydrate gum from aqueous reaction mixtures, which mixtures may further comprise viscosity reducing agents. Products produced according to these processes are also contemplated.

The present invention is more particularly directed to processes for recovering oxidized carbohydrate gums and viscosity reducing agents from reaction mixtures. Products produced according to these processes are also contemplated.

The present invention is also particularly directed to processes for increasing the solubility of dried or solid oxidized carbohydrate gum. Products produced according to these processes are also contemplated.

The present invention is further directed to compositions comprising oxidized carbohydrate gums and viscosity reducing agents. The present invention is more particularly directed to dry compositions comprising oxidized carbohydrate gums and viscosity reducing agents.

The present invention is further directed to processes for using compositions comprising oxidized carbohydrate gums and viscosity reducing agents. Products produced according to these processes are also contemplated.

The present invention is more particularly directed to processes for using dry compositions comprising oxidized carbohydrate gums and viscosity reducing agents. Products produced according to these processes are also contemplated.

The present invention is directed to a method for reducing viscosity in an aqueous polysaccharide composition comprising combining the aqueous composition with a non-aqueous viscosity reducing agent and wherein the water content of the composition is at least about 40 wt %.

In accordance with another aspect of the invention, the polysaccharide may comprise a carbohydrate gum.

Still further, the water content of the composition may be at least about 50 wt %, or at least about 80 wt %, or at least about 85 wt %.

In accordance with one aspect of the invention, the carbohydrate gum may include at least one member selected from the group including agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof. Preferably, carbohydrate gum comprises guar gum. Still further, the carbohydrate gum may include oxidized carbohydrate gum or oxidized guar gum.

In accordance with another aspect of the invention, the viscosity reducing agent may include at least one member selected from the group comprising polyethylene glycols and mixtures thereof. Still further, the polyethylene glycol may exhibit a molecular weight of from about 1,000 to about 50,000 daltons, or may have a molecular weight of greater than about 1,000 daltons.

The present invention contemplates the viscosity of the aqueous composition being reduced by at least about 10%, or 30%, or still further, 50%, and even further, 90%, compared to the polysaccharide composition before combining the polysaccharide composition with the viscosity reducing agent.

The present invention is further directed to a method for reducing viscosity of an aqueous composition of polysaccharide comprising combining viscosity reducing agent with the polysaccharide composition in an amount effective to form a two phase system comprising a continuous phase and a discontinuous phase. In accordance with one aspect of the present invention, the polysaccharide may include carbohydrate gum.

In accordance with the present invention, the continuous phase may be rich in viscosity reducing agent and the discontinuous phase may be rich in polysaccharide. Further, the viscosity of the aqueous composition is reduced by at least about 10% compared to the viscosity of the polysaccharide composition in the absence of viscosity reducing agent. Still further, the viscosity of the aqueous composition may be reduced by at least about 50%, and still further by at least about 90%, compared to the viscosity of the polysaccharide composition in the absence of viscosity reducing agent.

In accordance with one aspect of the invention, the polysaccharide is a carbohydrate gum and the viscosity reducing agent includes at least one polyethylene glycol. Still further, at least one polyethylene glycol exhibits a molecular weight greater than about 1,000 daltons.

In accordance with another aspect of the present invention, the water content of the composition is at least about 40 wt %. Still further, the water content of the composition may be at least about 50 wt %, or, still further, at least about 80 wt %, or, still further, at least about 85 wt %.

In accordance with another aspect of the present invention, the carbohydrate gum may include at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof. Preferably, the carbohydrate gum includes guar gum. Still further, the carbohydrate gum may comprise oxidized carbohydrate gum. Still further, the oxidized carbohydrate gum may include oxidized guar gum.

It is possible for the viscosity reducing agent to include at least one member selected from the group comprising polyethylene glycols and mixtures thereof. Further, the viscosity reducing agent may include at least one polyethylene glycol. At least one polyethylene glycol may exhibit a molecular weight of greater than about 1,000 daltons.

The present invention further includes a method for reducing viscosity of an aqueous composition of polysaccharide comprising combining said aqueous composition with an effective amount of non-aqueous viscosity reducing agent such that the viscosity of the polysaccharide composition is reduced by at least about 10% compared to the viscosity of the polysaccharide composition in the absence of the viscosity reducing agent. The polysaccharide may include a carbohydrate gum.

Still further, compared to the viscosity of the polysaccharide composition in the absence of the viscosity reducing agent, the viscosity of the polysaccharide composition may be reduced by at least about 30%, or at least about 50%, and still further, at least about 90%. The water content of the composition may be at least about 40 wt %, still further, the water content may be at least about 50 wt %, at least about 80 wt %, or at least about 85 wt %.

In accordance with the present invention, the carbohydrate gum may include at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof. Further, the carbohydrate gum may include guar gum or oxidized carbohydrate gum, such as oxidized guar gum.

The viscosity reducing agent may include at least one member selected from the group comprising polyethylene glycols and mixtures thereof. At least one polyethylene glycol may have a molecular weight of from about 1,000 to about 50,000 daltons, or may have a molecular weight of greater than about 1,000 daltons.

The present invention still further includes an aqueous composition including polysaccharide and non-aqueous viscosity reducing agent, wherein the water content of the composition is at least about 40 wt %. Still further, the polysaccharide may include carbohydrate gum. Still further, the composition may have a water content of the composition is at least about 50 wt %, or at least about 80 wt %, or at least about 85 wt %.

In accordance with the present invention, the carbohydrate gum may include at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof. The carbohydrate gum may comprise guar gum, and/or oxidized carbohydrate gum, such as, for example, oxidized guar gum.

The viscosity reducing agent may include at least one member selected from the group comprising polyethylene glycols and mixtures thereof. The polyethylene glycol may exhibit a molecular weight of from about 1,000 to about 50,000 daltons, or may exhibit a molecular weight of greater than about 1,000 daltons.

In accordance with the present invention, the composition may further include a component capable of oxidizing carbohydrate gum.

Further, the viscosity of the aqueous composition may be reduced by at least about 10%, or 30%, or 50%, or 90%, compared to the viscosity of the polysaccharide composition in the absence of the viscosity reducing agent.

The present invention further includes a composition including polysaccharide, aqueous solvent and viscosity reducing agent, wherein the aqueous polysaccharide composition is combined with an effective amount of viscosity reducing agent such that a two phase system comprising a continuous phase and a discontinuous phase is formed. In accordance with the present invention, the polysaccharide may include carbohydrate gum.

Further, the continuous phase may be rich in viscosity reducing agent and the discontinuous phase may be rich in polysaccharide.

Still further, the viscosity of the aqueous composition may be reduced by at least about 10%, 30%, 50% or 90%, compared to the viscosity of the polysaccharide composition in the absence of the viscosity reducing agent.

In accordance with the present invention, the polysaccharide may include carbohydrate gum and the viscosity reducing agent may include at least one polyethylene glycol. The polyethylene glycol may exhibit a molecular weight greater than about 1,000 daltons.

Still further, the water content of the composition may be at least about 40 wt %, or at least about 50 wt %, or at least about 80 wt % or at least about 85 wt %. Still further, the carbohydrate gum may include at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof. Still further, the carbohydrate gum may include guar gum, or an oxidized carbohydrate gum, such as, for example, oxidized guar gum.

The composition may further include polyethylene glycols, and mixtures thereof, as the viscosity reducing agent. Further, at least one polyethylene glycol may exhibit a molecular weight of greater than about 1,000 daltons, or may exhibit a molecular weight from about 200 to about 8,000,000 daltons.

The present invention further contemplates a composition for reducing viscosity of an aqueous composition of polysaccharide comprising combining an effective amount of non-aqueous viscosity reducing agent such that the viscosity of the polysaccharide composition is reduced by at least about 10% compared to the viscosity of the polysaccharide composition in the absence of the viscosity reducing agent.

In accordance with the present invention, the polysaccharide may include carbohydrate gum.

Still further, the viscosity of the aqueous composition may be reduced by at least about 10%, or 30%, or 50%, or 85%, or 90%, compared to the viscosity of the polysaccharide composition in the absence of the viscosity reducing agent.

Still further, the composition may include a carbohydrate gum and at least one polyethylene glycol. The polyethylene glycol may exhibits a molecular weight greater than about 1,000 daltons, or may exhibit a molecular weight of from about 200 to about 8,000,000 daltons.

Still further, the composition of the present invention may include a water content of at least about 40 wt %, or at least about 50 wt %, or at least about 80 wt %, or, still further, at least about 85 wt %.

The carbohydrate gum of the composition may include at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof. Still further, the carbohydrate gum may include a guar gum or an oxidized carbohydrate gum, such as oxidized guar gum.

The viscosity reducing agent may include at least one member selected from the group comprising polyethylene glycols, and mixtures thereof. The at least one polyethylene glycol may exhibit a molecular weight of greater than about 1,000 daltons.

The present invention further includes a method of oxidizing carbohydrate gum comprising combining carbohydrate gum, aqueous solvent, non-aqueous viscosity reducing agent and an oxidizing component under conditions effective to oxidize the carbohydrate gum.

Still further, the oxidizing component may include a member selected from the group consisting of potassium dichromate, potassium permanganate, and mixtures thereof. Still further, the oxidizing component may include a metal catalyst and hydrogen peroxide. Still further, the oxidizing component may include the enzyme galactose oxidase. Still further, the composition may further include the enzyme catalase.

The present invention further includes a method of resolubilizing solid oxidized carbohydrate gum comprising combining aqueous solvent with the oxidized carbohydrate gum under conditions effective to give a resolubilized composition a pH less than about 7.

In accordance with the present invention, the solid oxidized carbohydrate gum may have a water content of less than 60%. Still further, the resolubilized composition may have a pH less than about 6, or the resolubilized composition may have a pH less than about 5, or may have a pH of about 5.4. Still further the resolubilized composition may have a pH in the range of about 4 to about 7.

The method may further include heating the combined solid oxidized carbohydrate gum and aqueous solvent. In accordance with the present invention, the resulting temperature of the resolubilized composition may be about 90° C., or may be greater than about 80° C., or maybe in the range of about 65° C. to about 115° C. The present invention may further include adding shear effective to create turbulence in the combined solid oxidized carbohydrate gum and aqueous solvent. The method may further include adding shear simultaneously with heating the combined solid oxidized carbohydrate gum and aqueous solvent. The resulting temperature of the resolubilized composition may be about 90° C. and the pH may be less than about 6.

Further, in accordance with the present invention, the aldehyde content of the resolubilized oxidized carbohydrate gum may include at least approximately 70% of the aldehyde content of the dry oxidized carbohydrate gum. More preferably, the aldehyde content of the resolubilized oxidized carbohydrate gum includes at least approximately 80% of the aldehyde content of the dry oxidized carbohydrate gum, still more preferably, at least about 90% of the aldehyde content of the dry oxidized carbohydrate gum, and even more preferably, the aldehyde content of the resolubilized oxidized carbohydrate gum is substantially the same as the aldehyde content of the dry oxidized carbohydrate gum.

In accordance with the present invention, the carbohydrate gum may include oxidized guar.

Still further, the resulting aqueous composition may have a viscosity that is low enough for the composition to be pumpable.

Still further, the concentration of oxidized guar in the resulting solution may be less than 10% w/v, or less than 5% (w/v), or still further, less than 1.5% (w/v).

### BRIEF DESCRIPTION OF THE DRAWINGS

The foregoing and other objects, features, and advantages of the invention will be apparent from the following more particular description of the preferred embodiments, as illustrated in the accompanying drawings, in which reference characters refer to the same, or like, parts throughout the various views, and wherein:

FIG. 1 is a graph showing the results (% aldehyde) as determined by the reduction method described in Example 10 for Sample A from Example 16.

FIG. 2 is a graph showing the results (% aldehyde) as determined by the reduction method described in Example 10 for Sample B from Example 16.

FIG. 3 is a graph showing the amount of dissolved Sample A from Example 16 using refractive index area as a measure of dissolved sample, with various temperatures and blender times.

FIG. 4 is a graph showing the amount of dissolved Sample B from Example 16 using Refractive Index area as a measure of dissolved sample, with various temperatures and blender times.

FIG. 5 is a graph showing the product of the Refractive Index area and the percent aldehyde groups of dissolved Samples A and B from Example 16, with various temperatures and blender times.

FIG. 6 is a graph showing HPAEC analysis as described in Example 19 compared with Size Exclusion Chromatography data (as Refractive Index area) of dissolved Sample A from Example 16, with various temperatures and blender times.

FIG. 7 is a graph showing the amount of dissolved Sample B from Example 16, with various mixers and with a temperature of 70° C. and a mixing time of 30 minutes.

FIG. 8 is a graph showing the amount of dissolved Sample B from Example 17 (0.1% sample in tap water) measured as Refractive Index area with various pH, 5 and 10 minutes mixing times, and a mixing temperature of 90° C. The pH values in parentheses are those values measured before mixing.

FIG. 9 is a graph showing the percent aldehyde groups in Sample B from Example 17 dissolved in tap water with various pH, 5 and 10 mixing times and a mixing temperature of 90° C. The pH values in parentheses are those values measured before mixing.

FIG. 10 is a graph showing the product of the Refractive Index area and the percent aldehyde groups of the dissolved Sample B of Example 17 (0.1% in tap water), as a function of pH, 5 and 10 minutes mixing times, and a mixing temperature of 90° C. The pH values in parentheses are those values measured before mixing.

### DETAILED DESCRIPTION OF THE INVENTION

The present invention is generally directed to processes for improving the manageability of aqueous mixtures containing polysaccharides, more particularly, carbohydrate gums, and more particularly, oxidized carbohydrate gums. As described above, the inherent qualities of oxidized carbohydrate gums which make them desirable, such as the ability to increase the viscosity of an aqueous mixture, also make them difficult to work with. The present invention is directed to solving these problems.

Processes of the present invention are achieved by combining viscosity reducing agents with carbohydrate gums in aqueous mixtures.

As used herein, the term viscosity reducing agent is meant to include those agents which, when added to an aqueous mixture containing a carbohydrate gum, reduces the viscosity of the resulting mixture. This definition is not to be construed as a limitation on the processes of the present invention, which include adding viscosity reducing agents to aqueous mixtures, and/or adding components to aqueous mixtures which already contain viscosity reducing agents. As used herein, viscosity reducing agents do not include water.

When referring to components throughout this application, unless otherwise noted, reference to a component in the singular also includes combinations of the components. For example, as used herein, the term viscosity reducing agent is meant to include viscosity reducing agents, alone and/or in combination. As used herein, the term carbohydrate gum is meant to include carbohydrate gums, alone and/or in combination. Further, as used herein, an oxidizing component is meant to include oxidizing components, alone and/or in combination.

As the term is used herein, viscosity refers to the rheological properties of the systems discussed. Viscosity may be measured in a variety of manners, but is preferably measured by rotational viscometry. Preferable instruments for measuring viscosity include Brookfield viscometers (Brookfield Engineering Laboratories, Middleboro, Mass.).Preferable viscosity reducing agents comprise hydroxyl-containing compounds including, but not limited to, glycols, and preferably, polyethylene glycols. Polyethylene glycol, also called Apolyoxyethylene,” Apoly(ethylene oxide)” or Apolyglycol,” is a well known condensation polymer of ethylene glycol having the formula HOCH₂CH₂_{_{—}}(OCH₂CH₂_{_{—}})ₙ_{_{—}}OCH₂CH₂_{_{—}}OH or H(OCH₂CH₂),OH. Polyethylene glycols are discussed in U.S. Pat. No. 4,799,962, the entire contents of which is hereby incorporated by reference. Polyethylene glycol and methoxy polyethylene glycol are commercially available in various grades, e.g., under the trademark CARBOWAX (Union Carbide).

Preferable viscosity reducing agents comprise polyethylene glycols having molecular weights greater than about 200 daltons, more preferably greater than about 500 daltons, and most preferably greater than about 1000 daltons. Preferable viscosity reducing agents comprise polyethylene glycols having molecular weights less than about 8,000,000, more preferably less than about 4,000,000, more preferably less than about 2,000,000, more preferably less than about 900,000, more preferably less than about 750,000, more preferably less than about 500,000, more preferably less than about 300,000, more preferably less than about 100,000, even more preferably less than about 50,000, and most preferably less than about 20,000. Preferably, the viscosity reducing agents comprise polyethylene glycols having molecular weights from about 1,000 to about 900,000, more preferably from about 1,000 to about 50,000, and most preferably from about 6,000 to about 20,000.

Polysaccharides within the scope of this invention include water soluble polysaccharides which form a viscous solution when solubilized in water. Preferably, polysaccharides of the present invention include, without limitation, carbohydrate gums such as, by way of non-limiting example, polygalactomannan gums such as locust bean gum, guar gum, tamarind gum; gum arabic; polygalactoglucans; polygalactoglucomannans; polygalactan gums such as carrageenans and alginates; pectins; and cellulose derivatives including cellulose ethers. Derivatives of all of these polysaccharides are also contemplated. In preferred aspects, the polysaccharide or polysaccharide derivative is oxidized. Preferably, the polysaccharide comprises carbohydrate gums such as guar or its derivatives, and the oxidized polysaccharide comprises oxidized carbohydrate gum, preferably oxidized guar or an oxidized guar derivative. The aqueous mixture of carbohydrate gum and viscosity reducing agent may be prepared in any manner. The carbohydrate gum may be placed into an aqueous medium, followed by the addition of a viscosity reducing agent. The viscosity reducing agent may be added before, during, or subsequent to, a chemical or enzymatic, carbohydrate modifying reaction, to improve the manageability of the reaction mixture. Alternatively, a viscosity reducing agent may be present in the aqueous medium, to which is added carbohydrate gum. Also, the carbohydrate gum and viscosity reducing agent may be premixed and then added to water simultaneously. Of course, the mixtures may contain other components as well, including, for example, enzymes, or other oxidizing agents. In preferred aspects, a viscosity reducing agent is present in an aqueous reaction mixture in which a carbohydrate gum is oxidized.

It is possible, in accordance with the present invention, for a given concentration of carbohydrate gum in aqueous medium, to add viscosity reducing agent in an amount to reduce the viscosity of the mixture by at least about 10%, preferably at least about 30%, even more preferably, at least about 50% and even more preferably, at least about 90%.

The reduction in viscosity is preferably measured by taking the viscosity of the aqueous carbohydrate gum composition without the viscosity reducing agent present and comparing that measurement to the viscosity of the same carbohydrate gum composition with the viscosity reducing agent added thereto. The viscosity of the compositions are preferably measured by using a Brookfield DV viscometer with a LV2 spindle, at 22° C. with the spindle speed set at 2.5 rpm. In several cases, however, the viscosity of the carbohydrate gum composition will be much too high to be measured by a Brookfields viscosimeter, because the composition has a gel- or paste like consistency. In these cases, the reduction in viscosity can be described qualitatively, but not be quantified. The compositions will usually include carbohydrate gum, water and, when applicable, the viscosity reducing agent, and the viscosity will be measured under the same conditions. Moreover, it is noted that there will be occasions wherein the exact same conditions may not be precisely reproduceable and further wherein additional components may be present in the compositions, depending, for example, on the use intended for the carbohydrate gum mixture. In such occasions, the conditions should be maintained as close as possible when measuring the compositions with and without the viscosity reducing agent present to achieve results that are substantially comparable.

While not wishing to be bound by theory, it is believed that the effect of the viscosity reducing agent is caused by the formation of an aqueous two phase system.

Thus, it is understood that the present invention encompasses and includes any system whereby an aqueous two phase system is or can be formed which improves the mixing characteristics of the system.

The two phase system of the present invention will usually separate into two separate phases when agitation of the system has ceased. That is, when the two phase system is agitated, the two phases will become dispersed. However, the dispersion obtained will likely not be stable and, once the agitation ceases, the dispersion will not be maintained. Rather, the composition will separate into two phases. This particular two phase system is advantageous in that it facilitates the extraction of the polysaccharides from the other components of the composition, including water and viscosity reducing agent. When polysaccharides and viscosity reducing agent are being used, it is believed, without being bound by theory, that one phase is rich in polysaccharides and therefore viscous, the other phase is rich in viscosity reducing agent. If the viscosity of an aqueous solution of viscosity reducing agent is low, e.g. for a low MW polyethylene glycol, the viscosity of the aqueous two phase system containing a polysaccharides phase and a second phase containing the viscosity reducing agent will also be low, as long as the mixture is agitated and the phases are well dispersed. The dispersed system is believed to consist of a continuous phase rich in viscosity reducing agent and low in viscosity, and a discontinuous phase of dispersed polysaccharides solution with high viscosity. It is also believed that the two phase systems may be obtained by using suitable salts such as, for example, potassium phosphate, magnesium sulfate or potassium sulfate. Thus, while polyethylene glycol is exemplified as the viscosity reducing agent herein, it is believed that other agents, such as salts, which are able to establish an aqueous two-phase system would achieve the same effect, and would thus be within the scope of the present invention.

Polyethylene glycol's ability to form an aqueous two-phase system with a polysaccharides solution is dependent on its molecular weight. Higher molecular weight polyethylene glycols are able to induce phase separation at lower concentrations than lower molecular weight polyethylene glycols. Of course, this relationship exists as a continuum.

The concentration of the polysaccharides and the viscosity reducing agent in the composition are believed to determine the resulting concentrations of the two substances in the respective phases. For example, at a given guar concentration in the composition, the concentration of the guar phase after phase separation can be controlled by the concentration of the polyethylene glycol in the mixture. The higher the polyethylene glycol concentration, the higher the concentration of the guar in the guar-rich phase. In systems in which the viscosity reducing agent is used to reduce the viscosity of a reaction mixture, it is important to balance the components in the system for optimal results. For example, in an enzymatic oxidation of guar, galactose oxidase is present in the reaction mixture with guar. If the concentration of the polyethylene glycol is too low, a two-phase system will not form, and the polyethylene glycol will be less effective in reducing the viscosity. However, if the concentration of the polyethylene glycol is too high, the concentration of the guar in the guar-phase will become too high, resulting in a too viscous guar phase. This may lead to a significant reduction of the diffusion coefficient of the enzyme and thereby to lower conversion rates, which is less desirable. Thus preferably, the lower concentration of polyethylene glycol is that which is sufficient to impart two-phase behaviour to the system; the preferred upper concentration limit is that which allows the reaction to proceed. The preferred operating windows should be determined empirically, and will depend, but is not limited to, the type of gum (i.e., its molecular weight), the type of enzyme or enzyme mixtures and/or chemical oxidants, the type of polyethylene glycol (i.e., its molecular weight), and the concentrations of each of these components.

More particularly, the amount of viscosity reducing agent needed may depend on the molecular weight of the gum and/or the viscosity reducing agent. For example, gums of higher molecular weight may require different amounts of a viscosity reducing agent of a given molecular weight. As an example, when a guar gum with a molecular weight above 1×10⁶, is being used in conjunction with PEG 6,000 as the viscosity reducing agent, preferably, the concentration of the polysaccharides in the aqueous mixture is greater than about 0.1% w/v, more preferably greater than about 0.3% w/v, and most preferably greater than about 0.6 % w/v. Preferably, the concentration of the polysaccharides in the presence of viscosity reducing agent in the aqueous mixture is less than about 70% w/v, more preferably less than about 30% w/v, and most preferably less than about 10% w/v Preferably, the concentration of the polysaccharides in the presence of viscosity reducing agent in the aqueous mixture ranges from about 0.3 to about 30% w/v more preferably from about 0.6 to about 10% w/v and most preferably from about 1 to about 8% w/v. If other types of polysaccharides and/or viscosity reducing agents are used, i.e. a low MW guar gum, other preferred conditions may result.

Also, when a guar gum with a molecular weight above 1×10⁶ is being used in conjunction with PEG 6,000 as the viscosity reducing agent, preferably, the concentration of the viscosity reducing agent in the aqueous mixture is greater than about 0.5% w/v, more preferably greater than about 0.75% w/v and even more preferably greater than about 1% w/v. Preferably, the concentration of the viscosity reducing agent in the aqueous mixture is less than about 35% w/v, more preferably less than about 20% w/v, and even more preferably less than about 10% w/v. Most preferably, the concentration of the viscosity reducing agent in the aqueous mixture is about 8% w/v. Preferably, the concentration of the viscosity reducing agent in the aqueous mixture ranges from about 1 to about 35% w/v, more preferably from about 1 to about 10% w/v, and most preferably from about 1 to about 8% w/v. If other types of polysaccharides and/or viscosity reducing agents are used, i.e. a low MW guar gum, other preferred conditions may result. In aspects in which a polysaccharides is being oxidized, the viscosity reducing agent is preferably present in an amount which allows for a reduction in viscosity, yet does not significantly inhibit the reaction process.

Of course, as the water concentration of the aqueous mixtures comprising viscosity reducing agents and carbohydrate gums is reduced, e.g., the mixture is dried, the weight percentages of the respective components will be increased. Additionally, the aqueous mixture may contain a number of other components, including for example, enzymes or reactive materials, which will alter the weight percentage of the final mixture. The present invention is particularly useful for reducing the viscosity of reaction mixtures comprising a polysaccharides and its corresponding oxidase, because, as the oxidation reaction proceeds, the viscosity increases considerably. For example, the present invention is particularly useful in reaction mixtures in which guar, or some other galactose-containing carbohydrate gum, is oxidized by galactose oxidase, such as described in Frollini 1995, and M. J. Donnelly, 1999, the entire disclosures of which are hereby incorporated by reference. By including a viscosity reducing agent in accordance with the present invention, the viscosity of the reaction mixture is reduced considerably. Reaction mixtures particularly benefitted by the present invention include, but are not limited to, those comprising a polysaccharides selected from the group consisting of polygalactomannan gums such as locust bean gum, guar gum, tamarind gum, and gum arabic; polygalactan gums such as carrageenans, and alginates; pectins; cellulosics including cellulose ethers. Derivatives of these polysaccharides are also contemplated.

In accordance with the present invention, the viscosity reducing agent and the carbohydrate gum may be added in any order, e.g., the viscosity reducing agent may be added to the aqueous carbohydrate gum composition or the carbohydrate gum may be added to the aqueous solution of the viscosity reducing agent. Carbohydrate gum and viscosity reducing agent may also be mixed as dry materials and then added to water as a mixture.

Reaction mixtures particularly benefitted by the present invention include, but are not limited to, those further comprising an enzyme selected from the group consisting of alcohol oxidases, alcohol dehydrogenases, and peroxidases. Note that the present invention is not limited to enzyme reaction mixtures which include an oxidase; reaction mixtures which include hydrolases, or other classes of enzymes are contemplated as well. Hydrolytic enzymes contemplated include, but are not limited to, “-galactosidase, mannanase, cellulases, carrageenases, carrageenan sulfohydrolases, amylases, pectinases, and pectin esterases. Reaction mixtures that contain lyases such as pectin lyase and pectate lyase are also contemplated. Generally, any reaction mixture which includes a polysaccharides, and which would be benefitted by a reduction in viscosity, is within the scope of the present invention. Thus, for example, oxidation of the polysaccharide or polysaccharide derivative may be performed in a number of manners, including, but not limited to, enzymatic oxidation and chemical oxidation. In other words, the oxidation reaction can be accomplished in any manner, such as, for example, as described in any one of U.S. Pat. No. 3,297,604; No. 5,541,745; No. 6,022,717; WO 99/33879; WO99/34009; WO99/34058, the entire contents of which are hereby incorporated by reference as though set forth in full herein. The oxidation, whether chemical or enzymatic, is performed by an oxidizing component. Chemical oxidizing components include, but are not limited to, potassium dichromate, potassium permanganate, hypohalogenide with tetramethylpiperidinoxyl radical (TEMPO), a metal catalyst with hydrogen peroxide, and mixtures of the foregoing. Preferred metal catalysts include, but are not limited to, ferric chloride, cupric chloride, cobalt chloride, and mixtures thereof.

Enzymatic oxidation of the polysaccharide or polysaccharide derivative may be performed with a number of different enzymes, including, but not limited to, alcohol oxidases, alcohol dehydrogenases, and peroxidases, or a phenol oxidizing enzyme, together with a hydrogen peroxide source when the phenol oxidizing enzyme is a peroxidase, and an enhancing agent, as meant in WO99/32652, the disclosure of which is hereby incorporated by reference. Most preferably, the polysaccharide comprises polygalactomannan, polygalactoglucomannan, polygalactoglucan, or a derivative of any of the foregoing, and the enzyme comprises galactose oxidase. Because hydrogen peroxide is a byproduct of some oxidation reactions, care should be taken to avoid levels of hydrogen peroxide which are inhibitory to the oxidation reaction. It is believed, without being bound by theory, that high levels of hydrogen peroxide may damage the protein structure of galactose oxidase and may inhibit or slow down the galactose oxidase reaction. Accordingly, it is beneficial to maintain the hydrogen peroxide concentration in the reaction medium as low as possible. This hydrogen peroxide accumulation can often be avoided by adding an enzyme capable of converting hydrogen peroxide to water and oxygen. Such enzymes include, but are not limited to, catalase and peroxidase. The addition of catalase and peroxidase to an oxidation reaction involving oxidation reactions using galactose oxidase is the subject of an application filed on even date herewith application Ser. No. _____ (Attorney Docket No. V16766) “Compositions and Processes of Enzymatically Modified Polysaccharides”, the disclosure of which is hereby incorporated by reference.

In addition to maintaining the concentration of hydrogen peroxide low to protect the galactose oxidase (and any other enzymes that may be present, including without limitation the one electron oxidants), the hydrogen peroxide remover can also play a role in providing the molecular oxygen that is needed by galactose oxidase to carry out the oxidation reaction. Galactose oxidase converts the oxidizable galactose type of alcohol configuration to the corresponding aldehyde group (thus producing oxidized galactose) by reducing oxygen to hydrogen peroxide. It is known in the art to provide the oxygen via aeration techniques, including bubbling oxygen gas through the solution.

In accordance with the present invention, however, the necessary amount of oxygen may be provided by adding a hydrogen peroxide remover, such as catalase, which breaks down hydrogen peroxide into water and oxygen. In this way, the addition of oxygen to the reaction mixture is more efficient because it avoids the oxygen transfer from the gas to the liquid phase. Preferably, the hydrogen peroxide concentration that is optimal for a particular application is maintained, or substantially maintained, in the solution throughout the reaction.

The present invention is still further directed to aqueous mixtures produced in accordance with the present invention. Such compositions comprise carbohydrate gum and viscosity reducing agent. Aqueous compositions produced in accordance with the present invention are especially useful because their viscosity is reduced. For example, where known carbohydrate gum compositions would have been paste-like in consistency, the present composition comprising carbohydrate gum and viscosity reducing agent is fluid.

The present invention is directed to aqueous compositions, including but not limited to hydrosols, dispersions, solutions and the like which include water, viscosity reducing agent and carbohydrate gum in the various concentrations as described above. Depending on the intended use of the composition or the end product, however, it may be beneficial to remove water from the composition. Moreover, to reduce storage and shipping costs, it would be beneficial to have a product with reduced water content. Still further, some or all of the viscosity reducing agent can be removed from the compositions. The present invention is intended to include all such possibilities.

Thus, in one aspect of the present invention, the aqueous compositions can be further concentrated by removing water. The concentrating process can be achieved in a variety of manners including, but not limited to, evaporation, dialysis, and ultrafiltration. The concentrated mixtures may comprise from about 0 to 80 wt % water and about 0 to 50 wt % viscosity reducing agent. Compositions that have less than about 60 wt % water are considered “dried” or “solid” compositions. In another aspect of the present invention, some or all of the viscosity reducing agent may be removed from the composition while maintaining the water concentration, or some or all of the viscosity reducing agent may be removed from the composition in conjunction with the water removal. Thus, the concentrated or solid compositions produced in accordance with the present invention may comprise polysaccharides, oxidized or unoxidized, or polysaccharides derivatives, oxidized or unoxidized, with or without viscosity reducing agent. Of course, other materials may be contained in the solid compositions as well.

The solid composition may be further processed, depending on its ultimate application. Preferably, the solid composition is milled through a sieve. Preferably the sieve has a size cutoff of greater than 0.05 mm, more preferably greater than 0.1 mm, and most preferably greater than 0.15 mm. Preferably the milling sieve has a size cutoff of less than 0.8 mm, more preferably less than 0.5 mm, and most preferably less than 0.3 mm. The range of size of the milling sieve is preferably from about 0.8 mm to about 0.05 mm, more preferably from about 0.5 mm to about 0.1 mm, and most preferably from about 0.15 mm to about 0.3 mm.

The solid compositions of the present invention are advantageous in exhibiting a stability which is superior to known aqueous compositions of oxidized carbohydrate gum. In particular, a solid composition of the present invention may be stored at room temperature without the addition of preservatives.

Processes for re-solubilizing oxidized carbohydrate gum compositions of the present invention are also within the scope of the present invention.

When re-solubilizing the oxidized carbohydrate gum, it is important to maintain all, or substantially all, of the aldehyde content of the dry product. The processes of the present invention minimize the loss of aldehyde content in an oxidized carbohydrate gum. Preferably, the re-solubilized oxidized carbohydrate gum includes at least approximately 70% of the original aldehyde content. More preferably, the re-solubilized gum includes approximately at least 80% of the original aldehyde content. Even more preferably, the re-solubilized oxidized gum includes approximately at least 90-100% of the original aldehyde content. Re-solubilizing the compositions of the present invention involves at least adding a solvent (e.g., water) to the dried or solid oxidized carbohydrate gum composition with the resulting composition being at a low pH. Moreover, as will be discussed below, the composition can be subjected to elevated temperatures and/or shear to enhance the resolubilization process. For example, elevating the temperature and/or using high shear while maintaining a low pH can assist in maintaining all, or substantially all, of the aldehyde content of the oxidized carbohydrate gum.

For example, it may be particularly advantageous, in accordance with the present invention, to utilize all of the following four elements in re-solubilizing an oxidized carbohydrate gum composition: 1) solvent (e.g., water), 2) low pH, 3) elevated temperature, and 4) shear. If these four elements are used together, they may be performed in any order, but are preferably performed as 1 then 2 then 3 and 4 together. That is, preferably, water is first added to the mixture, the pH of the mixture is then adjusted, and then the mixture is simultaneously subjected to heating and shearing. Each element is described in more detail hereinafter.

Utilizing all four of the above listed elements allows the re-solubilization process to occur in substantially less time than without the use of the four elements. Specifically, the use of an elevated temperature, while maintaining the proper pH of the solution, allows the re-solubilization process to occur faster than at room temperature. Further, the use of shear, preferably high shear, allows the re-solubilization process to occur at a faster rate.

In the first re-solubilizing element, the composition of the present invention is preferably re-solubilized by placing it into a volume of water. The desired concentration of the composition and the presence or absence of viscosity reducing agent in the re-solubilized mixture may be chosen according to the application area of the composition. The present invention contemplates the addition of the components of the resulting composition in any order. For example, the solid guar may be added to the water and, if present, the viscosity reducing agent, or the viscosity reducing agent may be added either before or after adding the guar to the water or other aqueous medium. For example, if guar is the oxidized carbohydrate gum, and it is intended to be added to the wet end of a papermaking system, the solid or dried composition can be re-solubilized in absence of polyethylene glycol. The concentration of the guar solution is chosen such that the viscosity of the resulting solution is low enough for the composition to be pumpable. In this context, the preferred concentration of oxidized guar is less than 10% (w/v), more preferably less than 5% (w/v), and most preferably less than 1.5% (w/v). Preferably, for re-solubilizing the composition of the present invention in water, the composition comprises greater than 0.1% (w/v), more preferably more than 0.3% (w/v), and most preferably more than 0.5% (w/v) oxidized guar. For re-solubilizing the composition of the present invention in water, the composition preferably comprises from about 0.1 to 10% (w/v), more preferably from about 0.3 to 5% (w/v), and most preferably from about 0.5 to 1.5% (w/v) oxidized guar. In this stage, water may be added directly to the oxidized gum, or oxidized gum may be added to water.

For other fields of application, resolubilizing of the composition in the presence of the viscosity reducing agent and/or at higher concentrations is also contemplated. Of course, when a carbohydrate gum such as an oxidized cationic guar, with a reduced molecular weight is used, a much higher concentration of the polysaccharides solution can be chosen such that the viscosity of the resulting solution is low enough for the composition to be still pumpable.

The next element in re-solubilization that may be used is to adjust the pH of the mixture of oxidized gum and water, such that a low pH of the mixture is obtained at the start of the re-solubilization process. Of course, if the mixture already has a low pH, there is no need to adjust the same. Preferably, the resulting composition, at the conclusion of the re-solubilization process, will have a maximum pH of less than about 7. The lowering of the pH may be performed by adding an acid, including, but not limited to, phosphoric acid, nitric acid, formic acid, acetic acid, hydrochloric acid (HCl), and sulfuric acid (H₂SO₄). The acid is preferably added in a manner such that the pH of the mixture is adjusted to a pH of about 4 to about 7, more preferably the pH is adjusted to about 5 to about 6, and most preferably the pH is adjusted to about 5.4. While the pH of the composition can vary during the resolubilization process, it is also within the invention to maintain or substantially maintain the initial pH of the composition, such as, for example, by adding a buffer.

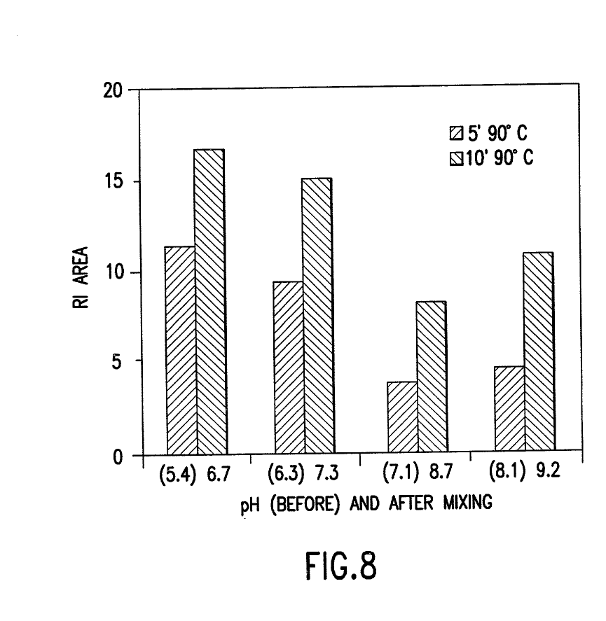

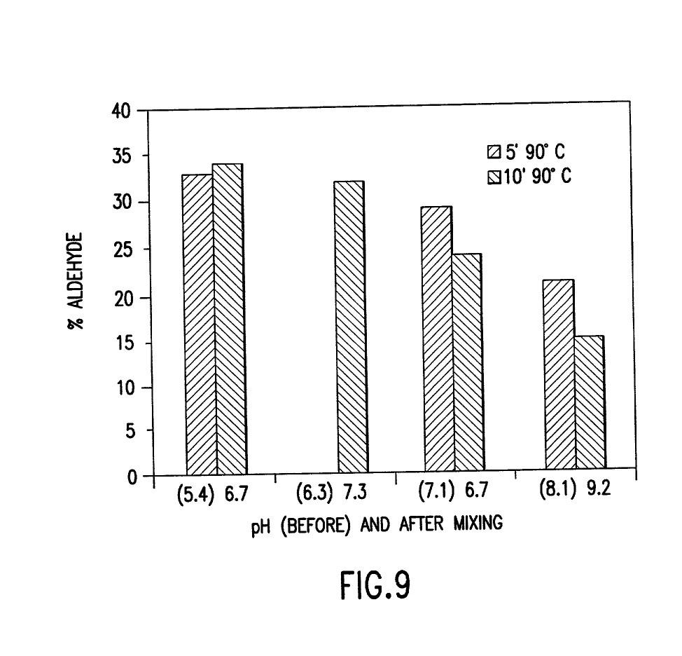

As can be seen from FIG. 8 and FIG. 9, at 90° C., if the pH of the composition is adjusted to be in the range of approximately 7-8, the re-solubilized oxidized gum has a lower aldehyde concentration. Whereas, if the pH of the composition is adjusted to be in the range of approximately 5-6, the re-solubilized oxidized gum has a higher aldehyde concentration.

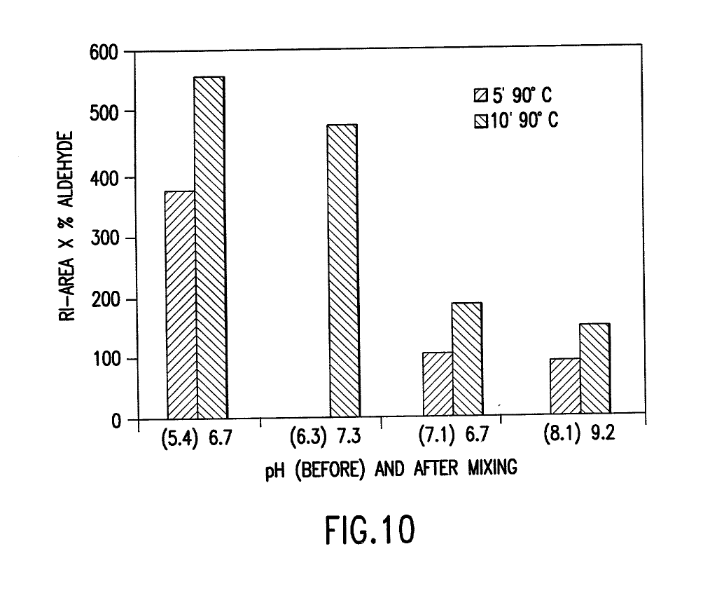

FIG. 8 shows the refractive index (RI) areas, which are a measure for the amount of oxidized guar dissolved, for a 0.1% (w/v) cationic oxidized guar sample having 35 (w/v) aldehyde groups, dissolved in tap water, with various pH and mixing times, with a mixing temperature of 90° C. FIG. 9 shows the percent aldehyde groups of a 0.1% (w/v) sample (with 35% (w/v) aldehyde groups), dissolved in tap water, with various pH and mixing times, with a mixing temperature of 90° C. (The analysis of this sample dissolved at a pH of 6.3 and mixed for 5 minutes failed, so this data is not presented.) FIG. 10 shows the product of the RI area and the percent aldehyde groups, given at various pH and mixing times, with a mixing temperature of 90° C.

These Figures show that, in accordance with at least one aspect of the present invention, acidifying the sample in tap water with a drop of acid seems to protect the aldehyde groups of the dissolved cationic oxidized guar during the mixing at high shear and temperature of 90° C. There is a dramatic decrease in the percent aldehyde groups on the dissolved cationic oxidized guar when the pH is greater than 7. There is also a large difference in the dissolution of the cationic oxidized guar between 5 minutes and 10 minutes mixing. Longer mixing time appears to dissolve more of the cationic oxidized guar without affecting the percent of aldehyde groups. The next element that may be used in the re-solubilization process is heating. Thus, in accordance with one aspect of the present invention, the low pH mixture may be heated. This element may be performed prior to the shear, or concurrently with the shear or without using the shear, but is preferably utilized with shear. Preferably the temperature for re-solubilization is greater than 60° C., more preferably greater than 70° C., and most preferably greater than about 80° C. Preferably, the temperature for re-solubilization is less than 120° C., more preferably less than 110° C., and most preferably less than 100° C. Preferably, the temperature for re-solubilization ranges from about 65° C. to about 115° C., more preferably from about 75° C. to about 105° C., and most preferably from about 85° C. to about 95° C. In a most preferred embodiment, the temperature of heating is about 90° C. The heating may be performed in any manner, including, but not limited to, induction, convection, conduction, radiation and steam addition.

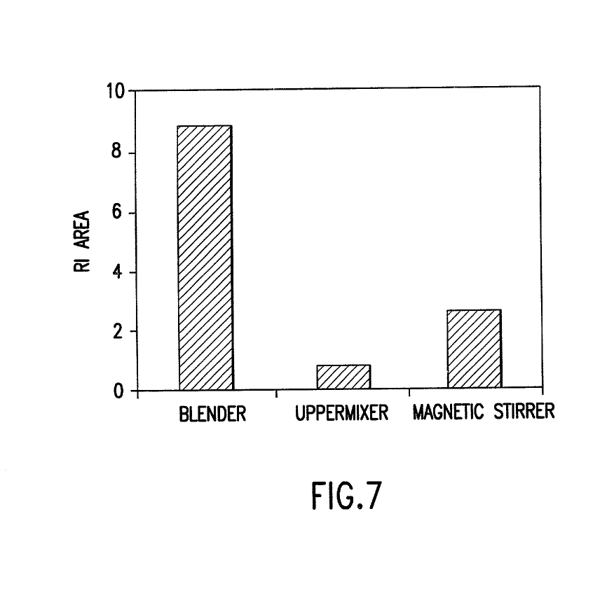

The present invention further contemplates using high shear in the re-solubilization process. The composition of the present invention may be re-solubilized with high shear and/or intensive turbulence so that the composition is visibly turbulent. The high shear may be applied in any manner, including, but not limited to, blenders, mechanical stirrers, jet cookers and the like. Preferably, the shear is applied in a device which allows for simultaneous heating although it is contemplated by the present invention to apply shear without necessarily applying heat. Examples of particularly preferred devices for heating and shearing include, but are not limited to, Warring Blender, Jet Cooker, Ultra Turrax T25 mixer (IKA Labortechnik; Janhe & Kunkel; Staufen, BRD), and other equipment which may be used for starch cooking or gum dissolution. More preferably, the shearing is performed with a Warring Blender or other comparable blender which provides the same or substantially the same mixing qualities, such as speeds and/or paddle size. Mixing time in the shearing device is preferably from about 10 to about 50 minutes, more preferably from about 20 to about 40 minutes, and most preferably about 30 minutes. As can be seen from FIG. 7, the Warring Blender, which provides high shear and turbulence to the composition, gives a higher concentration of aldehyde groups in the re-solubilized composition. The compositions utilizing the magnetic stirrer and the mechanical stirrer, which provides a lower shear and less turbulence than the Warring Blender, give a lower concentration of aldehyde groups. It is, thus, preferable to use a Warring Blender or other comparable device.

Thus, it appears that, when pH, temperature, and mixing time, are considered, the optimum conditions for dissolving cationic oxidized guar are: 1) dissolve the oxidized guar in acidified water such as acidified tap water, such that the resulting pH is approximately 5.4; 2) high shear, such as using an intensive turbulence blender (Warring Blender) at an elevated temperature, such as 90° C., and mixing for a period of time such as 10 minutes.

At any given stage, it may be desirable to separate the carbohydrate gum. The separation may be from the remainder of the mixture, including separation from the viscosity reducing agent and/or the water. This separation may be performed whenever the carbohydrate gum is in a liquid mixture. Thus, the separation may be performed before the composition is ever dried, or even after drying and re-solubilization. In theory, the separation is performed by taking advantage of the differential solubility of the carbohydrate gum and the viscosity reducing agent. Practically, the separation may be performed by adding a precipitating agent to the mixture which results in the precipitation of the component to be separated. In the case of carbohydrate gums, such precipitating agents include, but are not limited to, water-soluble organic solvents such as C₁-C₆ alcohols, including, but not limited to, isopropanol, ethanol, n-propanol, butanol, methanol, and/or t-butanol. Other precipitating agents include ketones such as acetone. Preferably, the other components, including the viscosity reducing agent, are soluble after the addition of the precipitating agent. Thus, the precipitated carbohydrate gum may be separated after precipitation.

Separation of the carbohydrate gum need not necessarily result in complete separation from the viscosity reducing agent. Some residual viscosity reducing agent may remain in the separated carbohydrate gum. Separation of the precipitated carbohydrate gum may be performed in any manner, including, but not limited to, centrifugation, sieving, filtration, and decanting. The precipitated separated carbohydrate gum may be washed if desired. Preferably such washing is performed with a solution which includes the precipitating agent. The carbohydrate gum may then be dried and milled; processes for drying and milling have been described above. The dried carbohydrate gum may be re-solubilized. Processes for re-solubilizing are described above.

Without further elaboration, it is believed that one skilled in the art can, using the preceding description, utilize the present invention to its fullest extent.

The following preferred specific embodiments are, therefore, to be construed as merely illustrative, and not limitative of the remainder of the disclosure in any way whatsoever.

### EXAMPLES

### Example 1

### Viscosity of Aqueous Guar/Polyethylene Glycol Mixtures

This example demonstrates that the viscosity of aqueous guar solutions can be dramatically decreased in presence of polyethylene glycol.

Aqueous mixtures of Polyethylene glycol (PEG 20,000; Merck) and neutral Guar gum (Supercol U; Hercules, Incorporated, Wilmington Delaware) were prepared by addition of the appropriate amounts of guar to aqueous solutions of polyethylene glycol. The viscosity of the resulting mixtures, as illustrated in Table 1, was determined using a Brookfield VII+ viscometer with a LV2 spindle. a spindle speed of 5 rpm was applied at 22° C.

TABLE 1
Viscosity (cP) of Aqueous Polyethylene Glycol/Guar Mixtures

| % | | | | | | | | | |
|---|---|---|---|---|---|---|---|---|---|
| (W/V) | % (W/V) PEG 20,000 | | | | | | | | |
| Guar | 0 | 1 | 2 | 3 | 5 | 10 | 15 | 20 | 30 |
| 0 | | 18 | 18 | 18 | 18 | 30 | 48 | 78 | 273 |
| 0.5 | 606 | | | | | | | | |
| 1 | 11680 | 1233 | 39 | 39 | | | | | |
| 2 | | 1809 | 96 | 60 | | | | | |
| 3 | | 4986 | 414 | 165 | | | | | |
| 4 | | | 1257 | 483 | | | | | |
| 5 | | | 4863 | 1215 | 483 | 237 | 162 | | |
| 6 | | | 13125 | 2981 | 897 | | | | |
| 7 | | | | 11110 | 1695 | | | | |
| 8 | | | | | 3864 | | | | |
| 9 | | | | | 13775 | | | | |
| 10 | | | | | 23220 | 1607 | 762 | 609 | 819 |
| 15 | | | | | | 54300 | 9105 | 1872 | 1509 |
| 20 | | | | | | | 60000 | 60000 | 3649 |
| 25 | | | | | | | | | 9795 |
| 30 | | | | | | | | | 60000 |

### Example 2

### Viscosity of Aqueous Polyethylene Glycol/Guar Mixtures Containing Different Types of Polyethylene Glycol

This example demonstrates that the viscosity of polyethylene glycol/guar mixtures depends on the molecular weight of the polyethylene glycol in the concentration range investigated.

To aqueous solutions of polyethylene glycol (PEG 200; PEG 300; PEG 400; PEG 600;PEG 1000; PEG 1500; PEG 4000; PEG 6,000 (BASF) and a high molecular weight polyethylene oxide (HMW PEO) Mn 900,000 (ACROS)), dry guar (Supercol U; Hercules Incorporated, Wilmington Delaware) was added to the appropriate concentrations. Viscosity of the resulting mixtures was judged by the visual appearance of the resulting mixtures.

Table 2—Influence of Molecular Weight of Polyethylene Glycol on the Viscosity of Polyethylene Glycol/Guar Mixtures (−=non viscous, +/−=intermediate viscosity, +=viscous, ++=solid gel).

TABLE 2
Influence of Molecular Weight of Polyethylene Glycol on the Viscosity of Polyethylene Glycol/Guar
Mixtures (− = non viscous, +/− = intermediate viscosity, + = viscous,
++ = solid gel)

| | Supercol U | PEG200 | PEG300 | PEG400 | PEG600 | PEG1000 | PEG1500 | PEG4000 | PEG6000 | HMW PEO | |
|---|---|---|---|---|---|---|---|---|---|---|---|
| No. | % (w/v) | % (w/v) | % (w/v) | % (w/v) | % (w/v) | % (w/v) | % (w/v) | % (w/v) | % (w/v) | % (w/v) | Visc. |
| 1 | 3 | 12 | | | | | | | | | + |
| 2 | 3 | 15 | | | | | | | | | +/− |
| 3 | 3 | 18 | | | | | | | | | − |
| 4 | 3 | | 12 | | | | | | | | + |
| 5 | 3 | | 15 | | | | | | | | − |
| 6 | 3 | | 18 | | | | | | | | − |
| 7 | 3 | | | 9 | | | | | | | ++ |
| 8 | 3 | | | 10 | | | | | | | + |
| 9 | 3 | | | 12 | | | | | | | +/− |
| 10 | 3 | | | | 3 | | | | | | ++ |
| 11 | 3 | | | | 9 | | | | | | + |
| 12 | 3 | | | | 12 | | | | | | − |
| 13 | 3 | | | | 15 | | | | | | − |
| 14 | 1 | | | | 1 | | | | | 1 | +/− |
| 15 | 2 | | | | 2 | | | | | 2 | ++ |
| 16 | 3 | | | | 3 | | | | | 3 | ++ |
| 17 | 4 | | | | 4 | | | | | 4 | ++ |
| 18 | 3 | | | | | 3 | | | | | ++ |
| 19 | 3 | | | | | | 5 | | | | +/− |
| 20 | 3 | | | | | | 6 | | | | +/− |
| 21 | 3 | | | | | | 7 | | | | − |
| 22 | 3 | | | | | | | 1 | | | ++ |
| 23 | 3 | | | | | | | 2 | | | ++ |
| 24 | 3 | | | | | | | 3 | | | +/− |
| 25 | 3 | | | | | | | | 1 | | ++ |
| 26 | 3 | | | | | | | | 2 | | + |
| 27 | 3 | | | | | | | | 3 | | − |
| 28 | 4 | | | | | | | | 3 | | − |
| 29 | 5 | | | | | | | | 3 | | − |
| 30 | 6 | | | | | | | | 3 | | +/− |
| 31 | 1 | | | | | | | | | 1 | +/− |
| 32 | 2 | | | | | | | | | 2 | +/− |
| 33 | 3 | | | | | | | | | 3 | +/− |
| 34 | 4 | | | | | | | | | 4 | + |
| 35 | 0 | | | | | | | | | 10 | ++ |

### Example 3

### Effect of Polyethylene Glycol on Alginic Acid

Example 3 demonstrates that the viscosity of alginic acid can be decreased in the presence of polyethylene glycol.

The viscosity of a 1% w/v alginic acid solution in 50 mM phosphate buffer, pH 7, is decreased by the addition of 1% w/v polyethylene glycol (PEG 6000). The viscosity of the mixtures is measured using a Brookfield DV+ viscometer with a LV2 spindle. The spindle speed was set at 2.5 rpm, at 22° C.

TABLE 3

| Sample | Viscosity (cP) |
|---|---|
| 1% alginic acid | 10540 |
| 1% alginic acid + 1% PEG 6000 | 2520 |

### Example 4

### Viscosity of Aqueous Cationic Guar/Polyethylene Glycol Mixtures

This example demonstrates that the viscosity of aqueous guar solutions can be dramatically decreased in the presence of polyethylene glycol.

Aqueous mixtures of polyethylene glycols (PEG) with molecular weights of 20,000, 9,000, and 6,000 and cationic guar gum (guar hydroxypropyl trimonium chloride, Guar C261, Hercules Incorporated, Wilmington Del.) were prepared by additional of the appropriate amounts of guar to aqueous solutions of polyethylene glycol in 50 mM potassium phosphate buffer, pH 7.0. The viscosities of the resulting mixtures, as illustrated in Table 4, were determined using a Brookfield VII+ viscometer with a LV3 spindle at 60 rpM, at 22° C.

TABLE 4

| % guar | 1 | 2 | 3 | 5 | 10 |
|---|---|---|---|---|---|
| | % (W/V) PEG 20,000 | | | | |
| 1 | 730 | 12 | 10 | 10 | 26 |
| 2 | | 34 | 22 | 22 | 38 |
| 3 | | 156 | 54 | 54 | |
| 4 | | 170 | 160 | 96 | 94 |
| 5 | | | 170 | 208 | |
| 6 | | | 390 | 260 | 184 |
| 7 | | | | 282 | |
| 8 | | | | 340 | 262 |
| 9 | | | | | |
| 10 | | | | | 414 |
| 12 | | | | | 710 |
| | % (W/V) PEG 9,000 | | | | |
| 1 | 676 | 296 | 11 | 20 | 22 |
| 2 | | | 26 | 22 | 30 |
| 3 | | | 44 | 56 | |
| 4 | | | 166 | 58 | 52 |
| 5 | | | 260 | 120 | |
| 6 | | | | 174 | 96 |
| 7 | | | | 312 | |
| 8 | | | | 460 | 188 |
| 9 | | | | | |
| 10 | | | | | 308 |
| | % (W/V) PEG 6,000 | | | | |
| 1 | 432 | 192 | 22 | 11 | 20 |
| 2 | | | 22 | 20 | 36 |
| 3 | | | | 22 | 24 |
| 4 | | | | 44 | 40 |
| 5 | | | | 88 | 58 |
| 6 | | | | 128 | |
| 7 | | | | 184 | 88 |
| 8 | | | | 506 | 116 |
| 9 | | | | | |
| 10 | | | | | 294 |
| 12 | | | | | 470 |

### Example 5

### Effect of PEG Addition on Viscosity of Cationic Oxidized Guar

Enzyme activities expressed in Units or International Units as used in this and subsequent examples are defined as:

Galactose Oxidase [EC 1.1.3.9]: One International Unit (IU) will convert one micromol galactose per minute at pH 7 and 25° C.

Peroxidase [EC 1.11.1.7]: One Unit will form 1.0 mg of purpurogallin from pyrogallol in 20 seconds at pH 6.0 at 20° C.

Laccase [EC 1.10.3.2]: One U will produce a difference in absorption at a wavelength of 530 nm of 0.001/min at pH 6.5 at 30° C. in a 3 ml reaction volume using syringaldazine as substrate.

Catalase [EC 1.11.1.6]: One Unit will decompose 1 micromol hydrogen peroxide per min at pH 7 at 25° C.

Cationic oxidized guar was prepared from cationic guar (hydroxypropyl trimonium chloride H1535-3, Hercules Incorporated, Wilmington Del.) by enzymatic oxidation. 50 ml of a 1% cationic guar solution in 50 mM potassium phosphate buffer, pH 7, supplemented with 0.5 mM CUSO₄, were placed in a 500 ml Erlenmeyer flask. To the guar solution, 30 μl of catalase solution (Reyonet S, 50,000 U/ml, Nagase) and a premix of 2.5 ml galactose oxidase solution (20 IU/ml, isolated from Dactylium dendroides fermentation, essentially as described by Tressel and Kossman, A simple purification procedure for galactose oxidase, Analytical Biochemistry, Vol. 105, pp. 150-153(1980)) and 0.21 ml soybean peroxidase solution (Wiley Organics, 475 U/ml), incubated for 1 minute, were added. For proper aeration, the guar solution was placed in an Erlemeyer flask which was shaken at 160 rpm in an incubator ambient temperature (22° C.). After 5 hours of reaction, a solid gel of oxidized guar was formed. Increasing amounts of solid PEG 6,000 (BASF) were added to the gel to yield final PEG concentrations of 1, 3, and 5% PEG. After each addition and thorough mixing with an ultra turrax T25 mixer (IKA Labortechnik; Jahne & Kunkel; Staufen, BRD), the viscosity of the mixture was measured on a Brookfield Viscosity Meter (spindle 3, 60 rpm), at 22° C. The measured results are summarized in Table 5.

TABLE 5

| PEG 6,000% | Brookfield Viscosity (cP) | Sample Appearance |
|---|---|---|
| 0 | not measurable | gel |
| 1 | 486 | large particles |
| 2 | 350 | small particles |
| 3 | 300 | fluid |

### Example 6

### Effect of Polyethylene Glycol on Enzyme Activity

Example 6 demonstrates how the activity of the enzyme combination galactose oxidase/horse radish peroxidase is only slightly inhibited by the presence of polyethylene glycol in the ABTS assay system as described in Example 7.Influence of the presence of polyethylene glycol 20,000 on the activity of galactose oxidase was measured by performing the standard galactose oxidase assay, as described in example 7, in presence of varying amounts of polyethylene glycol. Galactose oxidase, preincubated for three hours at ambient temperature in the presence of varying amounts of polyethylene glycol, was added to a 1 ml assay solution containing the same amounts of polyethylene glycol to a final activity of 1.34 IU/ml. Relative activities were determined with respect to the pure buffer control.

TABLE 6
Relative Activity of Galactose Oxidase in
Presence of Polyethylene Glycol 20,000

| | polyethylene glycol | relative |
|---|---|---|
| # | 20,000 [% (w/v)] | activity |
| 1 | 0 | 100 |
| 2 | 1 | 99 |
| 3 | 2 | 95 |
| 4 | 10 | 83 |

### Example 7

### Method for the Measurement of Galactose Oxidase Activity

Into a 1 ml cuvette are pipetted:

1. 960 μl reaction mixture consisting of 22 mg ABTS (2,2N-azino-di[3-ethyl-benzthiazolinsulfonate] and 5.4 g galactose (Sigma) dissolved in 50 mL 0.05 M potassium phosphate buffer, pH 7.0,

2. 15 μl peroxidase solution consisting of 5 mg horseradish peroxidase (200 units/mg, Sigma) dissolved in 5 ml 0.05M potassium phosphate buffer, pH 7.0, and

3. 25 μl sample solution.

The contents of in a spectrophotometer. From that data, activity expressed in International Units (IU) ca the cuvette are mixed shortly, then the change in absorbance at a wavelength of 405 nm is recorded n be calculated according to the standard calculations.

### Example 8

### Effect of Polyethylene Glycol on Guar Oxidation

Example 8 demonstrates that 1% guar added to 5% polyethylene glycol 20,000 can be efficiently converted to the polyaldehyde derivative. 0.2 gram neutral Guar gum (Supercol U ; Hercules Incorporated, Wilmington, Delaware) was added to a 50 ml plastic tube containing 20 ml of 50 mM potassium phosphate buffer, pH 7.0, supplemented with 0.5 mM CuSO₄ and 5% polyethylene glycol 20,000. After thoroughly mixing, this solution was transferred to a 250 ml Erlenmeyer flask and 200 μl 260.000 ^{IU}/ₘₗ catalase (beef liver, Boehringer Mannheim) was added. Prior to the enzyme reaction, the guar/polyethylene glycol solution was shaken in a rotary shaker (300 rpm; ambient temperature) to ensure air saturation of the solution.

30 IU galactose oxidase was pre-incubated with 60 U of horseradish peroxidase (200 units/mg, Sigma) for approximately 15 min. at ambient temperature. After the pre-incubation period, the galactose oxidase/HRP mixture was added to the guar/polyethylene glycol solution. This reaction mixture was incubated on a rotary shaker (300 rpm) for 22 hours at ambient temperature. After 22 hours incubation the reaction was stopped by heating the 20 ml reaction mixture for 10 min. at 80° C. in a water bath. The formed aldehyde level was determined using a NaBD₄ reduction method, described below in Example 10. 63% of all the galactose residues originally present in the sample had been converted into their 6-aldehyde derivative.

### Example 9

### Effect of Polyethylene Glycol on Guar Oxidation

Example 9 demonstrates that the galactose of guar can efficiently be converted to the aldehyde, in a mixture containing 1% guar to which 5% dry polyethylene glycol 20,000 was added. 0.2 gram dry Supercol U guar was added to a 50 ml plastic tube containing 20 ml potassium phosphate buffer, 50 mM, pH 7.0, supplemented with 0.5 mM CUSO₄. This suspension was thoroughly mixed until the guar was completely hydrated and dissolved. Subsequently 1.0 g polyethylene glycol 20,000 was added and dissolved into the guar solution. The guar/polyethylene glycol solution was transferred to a 250 ml Erlenmeyer flask and 200 μl 260.000 ^{IU}/ₘₗ catalase (beef liver, Boehringer Mannheim) was added. Prior to the enzyme reaction, the guar/polyethylene glycol solution was shaken in a rotary shaker (300 rpm; ambient temperature) to ensure air saturation of the solution. 30 IU galactose oxidase activity was pre-incubated with 60 units of horseradish peroxidase (200 units/mg, Sigma) for approximately 15 min. at ambient temperature. After the pre-incubation period, the galactose oxidase/HRP mixture was added to the guar/polyethylene glycol solution. This reaction mixture was incubated on a rotary shaker (300 rpm) for 22 hours at ambient temperature. After 22 hours incubation the reaction was stopped by heating the 20 ml reaction mixture for 10 min. at 80° C. in a water bath. The formed aldehyde level was determined using a NaBD₄ reduction method, described below in Example 10. 95% of all the galactose residues, originally present in the neutral guar gum sample, had been converted into their 6-aldehyde derivative.

### Example 10

### Determining the Amount of Galactose 6-Aldehyde in Oxidized Raffinose and Oxidized Guar

Example 10 teaches a method to determine the amount of galactose 6-aldehyde in enzymatically oxidized guar. The amount of galactose 6-aldehyde in oxidized raffinose or oxidized guar was determined according to the following procedure. Oxidized raffinose or oxidized guar samples were reduced by sodium borodeuteride treatment, hydrolyzed and reduced with sodium borodeuteride for a second time to form alditols. Acetylated alditols of mannose and galactose were baseline separated by gas chromatography (GC). The alditols of galactose and galactose 6-aldehyde elute at the same retention time. Using gas chromatography-mass spectrometry (GC-MS), the two galactitols could be distinguished because the incorporation of deuterium was different. Reduced galactose contained one deuterium (D1) and reduced galactose 6-aldehyde contained two deuteria (D2). Taking into account the isotope effects and the efficiency of labeling of non oxidized galactose the ratio of D1:D2 in the sample was calculated with the masses 187:188, 217:218, and 289:290, which is a measure for the aldehyde percentage. The isotope effect was calculated from guar reduced by NaBH₄. The efficiency of guar labeling was determined by reduction of guar with NaBD₄.

Method: 50 μl of 110 mM raffinose and 50 μl of 110 mM oxidized raffinose were labeled with deuterium using sodium borodeuteride (250 μl 10 mg/ml NaBD₄ in 2M NH₃, room temperature, 16 h) followed by hydrolysis (0.5 ml trifluoroacetic acid, 1 h at 121° C. ) and a second NaBD₄ reduction (250 μl 10 mg/ml NaBD₄ in 2M NH₃, 1 h at 30° C.). The residues were derivatized by acetylation (3 ml acetic anhydride, 0.45 ml methylimidazole, 30 min at 30° C.) and analyzed by GC-MS (HP5890 GC, HP5972 series MSD with E1 fragmentation) equipped with a DB-1 column (60 m×0.25 I.D.×0.25 3 m film thickness, 70-280° C. with 4° C./min, 280° C. for 5 min) with splitless injection (splitless time 60 sec).

200 3μ 0.3% oxidized guar were analyzed as described for raffinose.

### Example 11

### Efficiency of Enzymatic Oxidation of Guar and Raffinose at Different Polyethylene Glycol Concentrations

Example 11 demonstrates the efficiency of the enzymatic oxidation of guar in guar/polyethylene glycol mixtures of different concentrations. Example 11 includes a number of guar and raffinose oxidations performed under various reaction conditions following the standard procedure described in Examples 8 and 9. The hydration method specifies the order of addition of polyethylene glycol and guar to the water phase, G6P representing addition of dry guar to an aqueous polyethylene glycol solution and P6G representing addition of dry polyethylene glycol to an aqueous guar paste. Aldehyde contents of the guars were measured by the NaBD₄ reduction method. Enzyme productivity was defined as amount of aldehyde produced [Fmol] per IU of galactose oxidase.

TABLE 7
Examples for oxidation of Supercol U and Raffinose in polyethylene glycol mixtures

| | polyethylene glycol | | | | | | | incubation | |
|---|---|---|---|---|---|---|---|---|---|
| Guar | 20.000 | hydration | GOase | catalase | GOase:HRP | Aldehyde | productivity | time | Temperature |
| (%) | (%) | method | (IU/g) | (U/g) | (IU/U) | (%) | (3 mol/IU) | (h) | (° C.) |
| = | = | = | = | = | = | = | = | = | = |
| 0.3 | 0 | G → P | 150 | 1600000 | 1:2 | 38 | 5.6 | 20 | 6 |
| 0.3 | 1 | | 150 | 1600000 | 1:2 | 65 | 9.6 | 20 | 6 |
| 0.3 | 2 | | 150 | 1600000 | 1:2 | 75 | 11.2 | 20 | 6 |
| 0.3 | 5 | | 150 | 1600000 | 1:2 | 52 | 7.8 | 20 | 6 |
| 1 | 1 | | 45 | 240000 | 1:2 | 37 | 18.2 | 20 | 6 |
| 2 | 2 | | 22.5 | 1600000 | 1:2 | 22 | 21.8 | 20 | 6 |
| 1 | 1 | | 150 | 480000 | 1:2 | 66 | 9.8 | 20 | 6 |
| 2 | 2 | | 150 | 240000 | 1:2 | 58 | 8.6 | 20 | 6 |
| 1 | 2 | G → P | 150 | 240000 | 1:2 | 65 | 9.6 | 22 | 6 |
| 2 | 2 | | 150 | 120000 | 1:2 | 57 | 8.4 | 22 | 6 |
| 2 | 2 | | 24 | 120000 | 1:2 | 22 | 20.4 | 22 | 6 |
| 3 | 2 | | 150 | 80000 | 1:2 | 49 | 7.2 | 22 | 6 |
| 1 | 3 | | 150 | 240000 | 1:2 | 59 | 8.8 | 22 | 6 |
| 2 | 3 | | 150 | 120000 | 1:2 | 49 | 7.2 | 22 | 6 |
| 3 | 3 | | 150 | 80000 | 1:2 | 45 | 6.6 | 22 | 6 |
| 4 | 3 | | 150 | 60000 | 1:2 | 37 | 5.4 | 22 | 6 |
| 3 | 5 | | 150 | 80000 | 1:2 | 31 | 4.6 | 22 | 6 |
| 4 | 5 | | 150 | 60000 | 1:2 | 27 | 4 | 22 | 6 |
| 5 | 5 | | 150 | 48000 | 1:2 | 22 | 3.2 | 22 | 6 |
| 0.3 | 3 | G → P | 150 | 720000 | 1:3 | 57 | 8.4 | 3 | 22 |
| 0.6 | 3 | | 75 | 360000 | 1:3 | 39 | 11.6 | 3 | 22 |
| 1 | 3 | | 45 | 217000 | 1:3 | 25 | 12.4 | 3 | 22 |
| 2 | 3 | | 22.5 | 108000 | 1:3 | 12 | 11.8 | 3 | 22 |
| 3 | 3 | | 15 | 72000 | 1:3 | 9 | 13.4 | 3 | 22 |
| 4 | 3 | | 11 | 54000 | 1:3 | 4 | 8 | 3 | 22 |
| 0.3 | 3 | G → P | 150 | 720000 | 1:3 | 86 | 12.8 | 6 | 22 |
| 0.6 | 3 | | 75 | 360000 | 1:3 | 69 | 20.4 | 6 | 22 |
| 1 | 3 | | 45 | 217000 | 1:3 | 54 | 26.6 | 6 | 22 |
| 2 | 3 | | 22.5 | 108000 | 1:3 | 27 | 26.6 | 6 | 22 |
| 3 | 3 | | 15 | 72000 | 1:3 | 16 | 23.8 | 6 | 22 |
| 4 | 3 | | 11 | 54000 | 1:3 | 12 | 23.8 | 6 | 22 |
| 0.3 | 3 | G → P | 150 | 720000 | 1:3 | 86 | 12.8 | 24 | 22 |
| 0.6 | 3 | | 75 | 360000 | 1:3 | 71 | 21 | 24 | 22 |
| 1 | 3 | | 45 | 217000 | 1:3 | 61 | 30.2 | 24 | 22 |
| 2 | 3 | | 22.5 | 108000 | 1:3 | 26 | 25.6 | 24 | 22 |
| 3 | 3 | | 15 | 72000 | 1:3 | 16 | 23.8 | 24 | 22 |
| 4 | 3 | | 11 | 54000 | 1:3 | 10 | 19.8 | 24 | 22 |
| 1 | 1 | G → P | 150 | 260000 | 1:2 | 47 | 7 | 22 | 22 |
| 1 | 2 | | 150 | 260000 | 1:2 | 78 | 11.6 | 22 | 22 |
| | | | 150 | | | | 9.4 | | |
| 1 | 5 | | | 260000 | 1:2 | 63 | | 22 | 22 |
| 1 | 10 | | 150 | 260000 | 1:2 | 7 | 1 | 22 | 22 |
| 1 | 30 | | 150 | 260000 | 1:2 | 1 | 0.2 | 22 | 22 |
| 20 ml 66 mM | 1 | Raffinose | 150 | 260000 | 1:2 | 96 | 14.2 | 22 | 22 |
| 20 ml 66 mM | 2 | Raffinose | 150 | 260000 | 1:2 | 99 | 14.6 | 22 | 22 |
| 20 ml 66 mM | 5 | Raffinose | 150 | 260000 | 1:2 | 97 | 14.4 | 22 | 22 |
| 20 ml 66 mM | 10 | Raffinose | 150 | 260000 | 1:2 | 71 | 10.4 | 22 | 22 |
| 20 ml 66 mM | 30 | Raffinose | 150 | 260000 | 1:2 | 43 | 6.4 | 22 | 22 |
| 1 | 1 | P → G | 150 | 260000 | 1:2 | 95 | 14 | 22 | 22 |
| 1 | 3 | | 150 | 260000 | 1:2 | 96 | 14.2 | 22 | 22 |
| 1 | 5 | | 150 | 260000 | 1:2 | 95 | 14 | 22 | 22 |
| 1 | 6 | | 150 | 260000 | 1:2 | 88 | 13 | 22 | 22 |
| 1 | 7 | | 150 | 260000 | 1:2 | 85 | 12.6 | 22 | 22 |
| 1 | 8 | | 150 | 260000 | 1:2 | 72 | 10.6 | 22 | 22 |
| 1 | 9 | | 150 | 260000 | 1:2 | 58 | 8.6 | 22 | 22 |
| 1 | 10 | | 150 | 260000 | 1:2 | 41 | 6 | 22 | 22 |
| 1 | 15 | | 150 | 260000 | 1:2 | 9 | 1.4 | 22 | 22 |
| 1 | 20 | | 150 | 260000 | 1:2 | 7 | 1 | 22 | 22 |
| 4 | 2 | P → G | 9.5 | 10000 | 1:2 | 9 | 21 | 2.5 | 22 |
| 4 | 2 | | 9.5 | 10000 | 1:2 | 13 | 30.4 | 24 | 22 |
| | | | 48 | | | | 16 | | |
| 4 | 2.5 | P → G | | 10000 | 1:2 | 34 | | 3 | 22 |
| 4 | 2.5 | | 48 | 10000 | 1:2 | 36 | 16.8 | 6 | 22 |
| 4 | 2.5 | | 48 | 10000 | 1:2 | 42 | 19.6 | 20 | 22 |
| 8 | 5 | P → G | 24 | 10000 | 1:2 | 11 | 10.2 | 1 | 35 |
| 8 | 5 | | 24 | 10000 | 1:2 | 11 | 10.2 | 2 | 35 |
| 8 | 5 | | 24 | 10000 | 1:2 | 13 | 12.2 | 4 | 35 |
| 8 | 5 | | 24 | 10000 | 1:2 | 14 | 13 | 22 | 35 |

### Example 12

### Preparation of Oxidized Cationic Guar in Presence of Poyethylene Glycol

In a 10 l container, 51 of a 50 mM potassium phosphate buffer solution with a pH of 7 was prepared. While the solution was stirred, 25 mg CuSO₄ was added. 50 g PEG 6000 (BASF, Ludwigshafen, Germany) were added to the buffer solution which was stirred with a mechanical stirrer until the PEG was fully dissolved. 50 g cationic guar (N-Hance 3198, Hercules Incorporated, Wilmington, DE) was then added to the solution, which was further stirred until the composition was homogeneous. The thus prepared mixture contained 1% wv cationic guar and 1% w/v PEG 6000. 1.5 ml of catalase (Reyonet S, Nagase, Japan, 50.000 U/ml) were added to the solution. The guar mixture was then poured into a 7 l fermentor (Biocontroler ADI 1030, Applicon, Schiedam, Netherlands). The stirrer was adjusted to a speed of 1200 rpm, the solution was aerated with compressed air at a rate of 1.277 l/min. a mixture of 125 ml of a galactose oxidase preparation (20 IU/ml, from Dactylium dendroides fermentation) and 10.53 ml soy bean peroxidase solution (Wiley Organics, 475 U/ml) was prepared and incubated for 5 min, after which the mixture was added to the fermentor. The reaction mixture was aerated under maintained agitation for five hours at ambient temperature to allow the oxidation to proceed.

After 5 h reaction time, the content of the fermentor was poured slowly and under gentle stirring into a 10 l container charged with 5 l of isopropanol. The mixture was stirred for another two hours, the precipitated oxidized cationic guar was then allowed to settle overnight. The reaction product was recovered by filtration over a Whatman-1 filter paper using a Büchner funnel. The collected precipitate was washed twice with 1150% isopopanol in water. The washed product was allowed to dry overnight at ambient temperature and pressure in the fume cupboard.

The dried product was milled on a Retsch DR100 mill with decreasing sieve sizes, starting from a size cutoff of 0.8 mm, down to a final size cutoff of 0.15 mm. Total solids of the dried and milled material was determined by placing a weighed sample in a vacuum oven at 30° C. for 16 h. Conversion was measured by the reduction method described in example 10 and was found to be 38% in the dry product.

### Example 13

### Preparation of Oxidized Cationic Guar in Presence of Poyethylene Glycol

In a 250 ml beaker, 200 ml of a 50 mM potassium phosphate buffer solution with a pH of 7 was prepared and supplemented with 50 mM CuSO₄. 10 g PEG 6000 (BASF, Ludwigshafen, Germany) were added to the buffer solution which was stirred with a mechanical stirrer until the PEG was fully dissolved. 10 g cationic guar (N-Hance 3198, Hercules Inc., Wilmington, Del.) were then added to the solution, which was further stirred until the composition was homogeneous. The thus prepared mixture contained 5% wv cationic guar and 5% w/v PEG 6000. 60 ml of catalase (Reyonet S, Nagase, Japan, 50.000 U/ml) were added to the solution.

A mixture of 75 ml of a galactose oxidase preparation (20 IU/ml, from Dactylium dendroides fermentation) and 6.32 ml soy bean peroxidase solution (Wiley Organics, 475 U/ml) was prepared and incubated for 5 min, after which the mixture was added to the reaction mixture. The reaction mixture was poured into a 1 l Erlenmeyer flask which was shaken for 5 h in an incubator at 300 rpm.

After 5 h reaction time, the content of the Erlenmeyer flask was poured slowly and under gentle stirring into a 11 beaker charged with 200 ml of isopropanol. The mixture was stirred for another two hours, the precipitated oxidized cationic guar was then allowed to settle overnight. The reaction product was recovered by filtration over a Whatman-1 filter paper using a Büchner funnel. The collected precipitate was washed twice with 50 ml 50% isopopanol in water. The washed product was allowed to dry overnight at ambient temperature and pressure in the fume cupboard.

The dried product was milled on a Retsch DR100 mill with decreasing sieve sizes, starting from a size cutoff of 0.8 mm, down to a final size cutoff of 0.15 mm. Total solids of the dried and milled material was determined by placing a weighed sample in a vacuum oven at 30° C. for 16 h. Conversion was measured by the reduction method described in example 10 and was found to be 30% in the dry product.

### Example 14

### Preparation of Oxidized Cationic Guar in Presence of Poyethylene Glycol

In a 250 ml beaker, 100 ml of a 50 mM potassium phosphate buffer solution with a pH of 7 was prepared and supplemented with 50 mM CuSO₄. 3.5 g PEG 6000 (BASF, Ludwigshafen, Germany) were added to the buffer solution which was stirred with a mechanical stirrer until the PEG was fully dissolved. 3.5 g cationic guar (N-Hance 3198, Hercules Inc., Wilmington, Del.) were then added to the solution, which was further stirred until the composition was homogeneous. The thus prepared mixture contained 3.5% wv cationic guar and 3.5% w/v PEG 6000. 15.75 ml of catalase (Reyonet S, Nagase, Japan, 50.000 U/ml) were added to the solution.

A mixture of 19.7 ml of a galactose oxidase preparation (20 IU/ml, from Dactylium dendroides fermentation) and 1.66 ml soy bean peroxidase solution (Wiley Organics, 475 U/ml) was prepared and incubated for 5 min, after which the mixture was added to the reaction mixture. The reaction mixture was poured into a 500 ml Erlenmeyer flask which was shaken for Sh in an incubator at 300 rpm.

After 5 h reaction time, the content of the Erlenmeyer flask was poured slowly and under gentle stirring into a 1 liter beaker charged with 100 ml of isopropanol. The mixture was stirred for another two hours, the precipitated oxidized cationic guar was then allowed to settle overnight. The reaction product was recovered by filtration over a Whatman-1 filter paper using a Büchner funnel. The collected precipitate was washed 4 times with 50 ml 50% isopopanol in water. The washed product was allowed to dry overnight at ambient temperature and pressure in the fume cupboard. The dried product was milled on a Retsch DR100 mill with decreasing sieve sizes, starting from a size cutoff of 0.8 mm, down to a final size cutoff of 0.15 mm. Total solids of the dried and milled material was determined by placing a weighed sample in a vacuum oven at 30° C. for 16 h. Conversion was measured by the reduction method described in example 10 and was found to be 28% in the dry product.

### Example 15

### Application of the Product from Examples 12, 13, and 14 as Strength Additive in Paper

For application testing of the products synthesized as described in the preceding examples, 0.3% w/v solutions of these products were prepared in the following way: 600 mg of the oxidized product was dispersed in 200 ml tap water. The pH was then adjusted to a value of 5.4 by addition of a drop of concentrated hydrochloric acid. The solution was then poured into a Warring blender equipped with a thermostateable sample container, which was kept on a temperature of 90° C. The solution was mixed at 19500 rpm for ten minutes and was then allowed to cool back to room temperature. The solutions prepared in this way were clear, highly viscous solutions. Paper making procedure:

Pulp was made from a 80/20 Thermomechanical pulp/Softwood mixture (Rygene-Smith & Thommesen TMP225, ex M&M Board Mill, Eerbeek, Netherlands; OULU-pine ECF softwood pulp, Berghuizer Mill, Netherlands). The process water used had 100 ppm CaCO₃ hardness, 50 ppm CaC 03 alkalinity, and a pH of 7.0-7.5. Water temperature was ambient temperature. The two pulps were refined before mixing on a Hollander beater. TMP was refined at 2.2% consistency for 10 min with 12 kg of weight to a freeness of 47° SR. The softwood pulp was refined at 2.16% consistency for 29 min with 12 kg weight to a freeness of 26° SR. Handsheets were made on a Noble&Wood Handsheet Paper Machine to a grammage of 50 gram per square meter. The pH of the white water was 7-7.5. Dry content of the sheets after the wet press was 32.1%, contact time on the drying cylinder was 41 sec at 105° C., and the final moisture content of the paper was 3.8%. The guar solutions were added to the proportioner of the handsheet machine. Paper testing:

Calliper was measured with the Messmer Büchel Micrometer (model M372200). Tensile strength was measured with a Zwick tensile tester, crosshead speed of 20 mm/min, paper was used in single ply and 15 mm wide. For wet tensile testing, the paper was soaked in demineralized water for 1 min prior to testing. All tests were carried out at 23° C. and 50% relative humidity. The paper was aged for one week under these conditions before testing. Results of the strength test are summarized in the Table 8 below.

TABLE 8

| | | | DRY | WET |
|---|---|---|---|---|
| | ADDITION | GRAMMAGE | TENSILE | TENSILE |
| ADDITIVE | % db | g/m² | kN/m | kN/m |
| blank | — | 50 | 1.39 | 0.05 |
| Example 12 | 0.2 | 54 | 1.58 | 0.05 |
| Example 12 | 0.4 | 52 | 1.83 | 0.24 |
| Example 12 | 0.8 | 52 | 2.01 | 0.32 |
| Example 13 | 0.2 | 52 | 1.62 | 0.14 |
| Example 13 | 0.4 | 52 | 1.59 | 0.19 |
| Example 13 | 0.8 | 50 | 1.77 | 0.22 |
| Example 14 | 0.2 | 51 | 1.54 | 0.15 |
| Example 14 | 0.4 | 51 | 1.61 | 0.18 |
| Example 14 | 0.8 | 50 | 1.74 | 0.24 |

### Example 16

### Dissolution of Oxidized Guar with Varied Temperature and Mixing Time

The experiments described in this example were performed to determine the preferred mixing and temperature conditions for dissolving oxidized cationic guar. The testing is performed with two oxidized cationic guar samples, one having 50% aldehyde groups (Sample A), and one having 35% aldehyde groups (Sample B). Both dried oxidized cationic guar samples were prepared in an 1% cationic guar (N-Hance 3198; Hercules Incorporated, Wilmington, Delaware) and 1% PEG 6000 (BASF) solution essentially as described in Example 12. Dried oxidized cationic guar samples were added to tap water to a final concentration of 0.1% (w/v) and mixed in a Warring Blender at mixing position 6 (of 7), at different temperatures (50, 70 and 90° C.). A concentration of 0.1% (w/v) was chosen as this concentration proved to be best suited for size exclusion chromatographs (SEC) analysis as described in Example 18. The percentage of aldehyde groups in these samples was determined using the procedure as described in Example 10.

Subsequent to mixing in the blender samples were filtered through a 0.45 urn filter (Schleicher & Schuell, Spartan 13/20) to obtain the dissolved fraction that was analyzed with size exclusion chromatography (SEC) to measure the amount of dissolved oxidized cationic guar. Two detectors are connected to the SEC, a refractive index (RI) detector and a viscosity detector. The area of the detected RI peak was chosen as a measure for the amount of dissolved oxidized cationic guar. Mannose concentration as determined by HPAEC-PAD was used to determine the amount of cationic oxidized guar in solution by an independent alternative method (see Example 19).

Table 9 shows how the pH of the sample changes with variations in blending time and temperature.

TABLE 9
pH of Samples A and B After Mixing
with Various Times and Temperatures

| Temperature | Blender Time | Sample A | Sample B |
|---|---|---|---|
| (EC) | (minutes) | pH | pH |
| 50 | 5 | 8.32 | 7.81 |
| 50 | 10 | 8.5 | 8.26 |
| 50 | 30 | 8.4 | 8.28 |
| 70 | 5 | 8.64 | 8.58 |
| 70 | 10 | 8.63 | 8.62 |
| 70 | 30 | 8.58 | 8.55 |
| 90 | 5 | 9.07 | 9.02 |
| 90 | 10 | 9.05 | 9.09 |
| 90 | 30 | 8.95 | 9.01 |

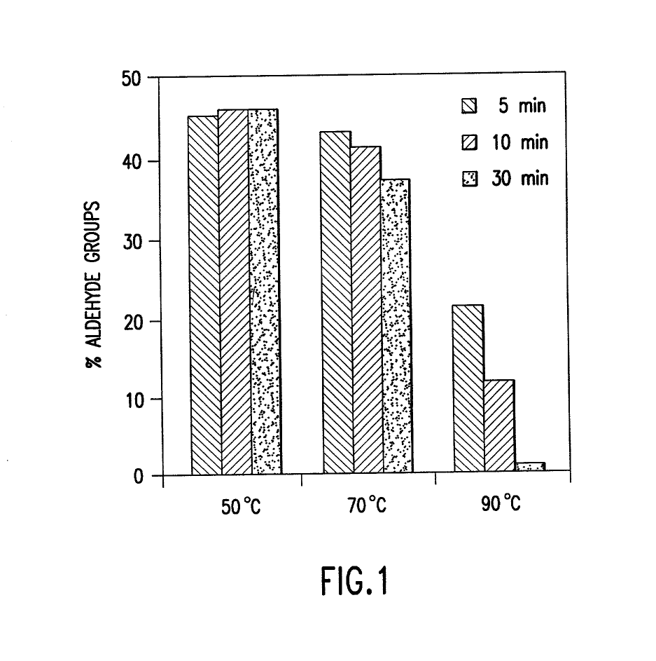

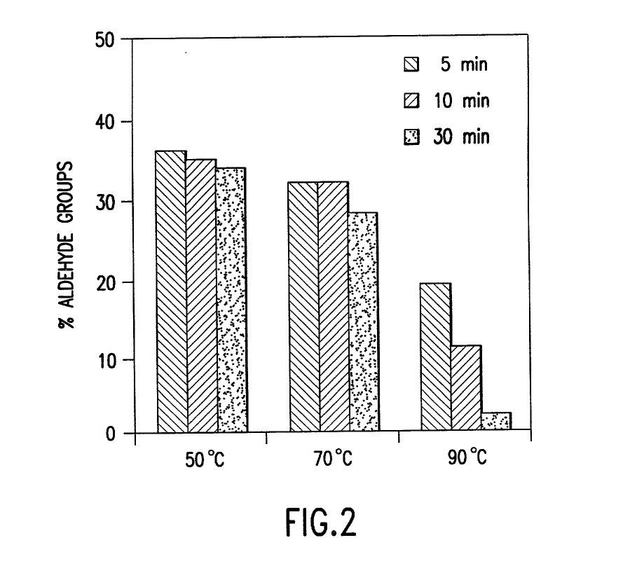

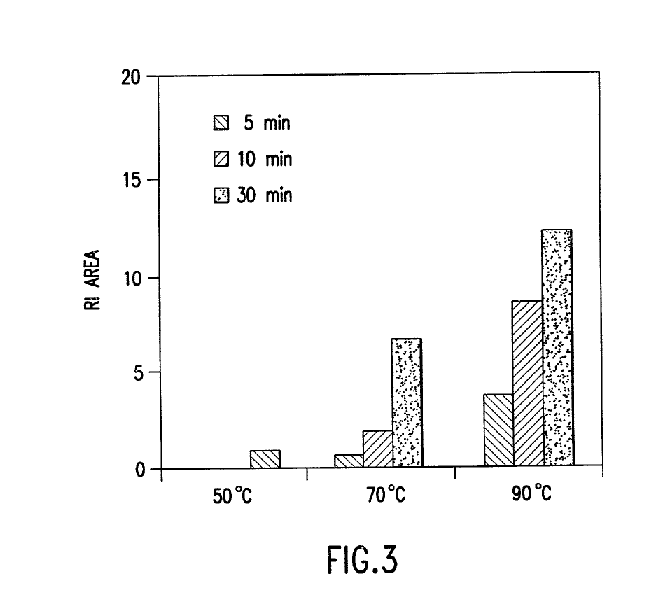

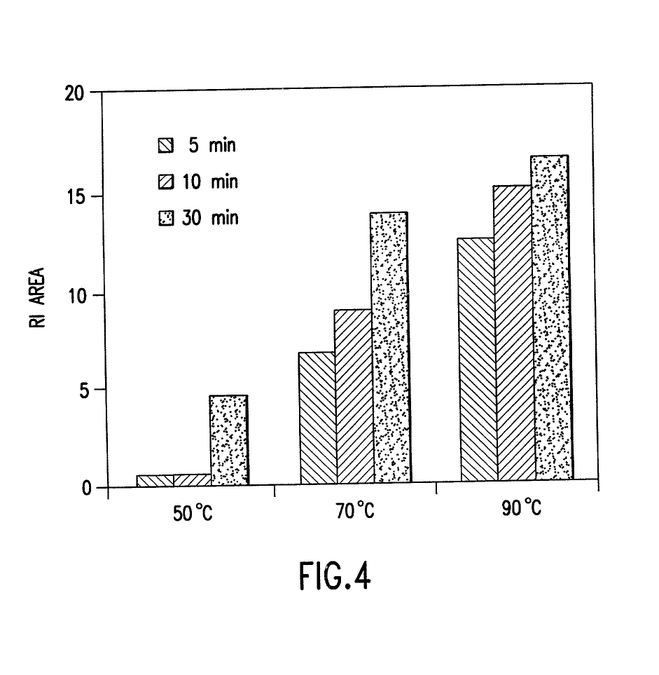

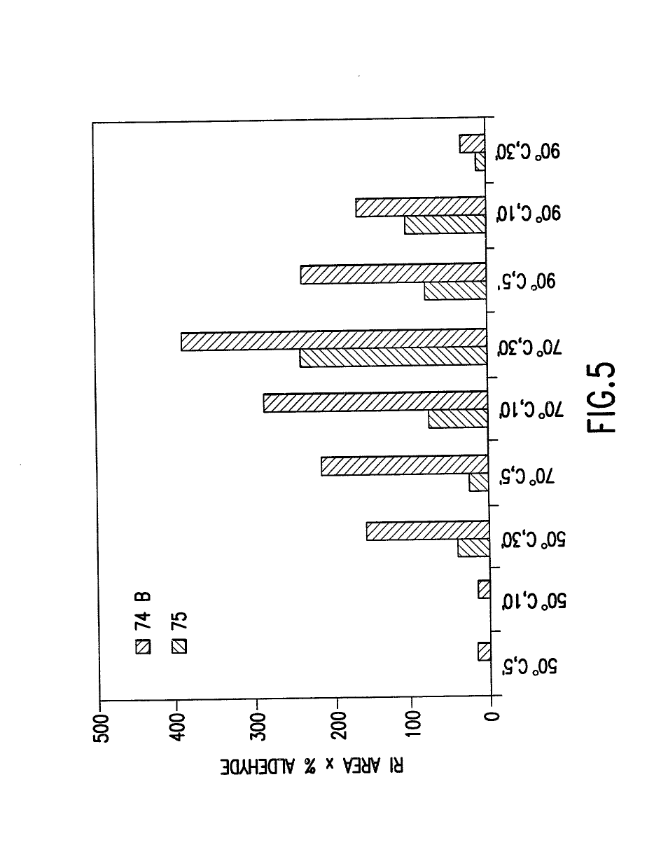

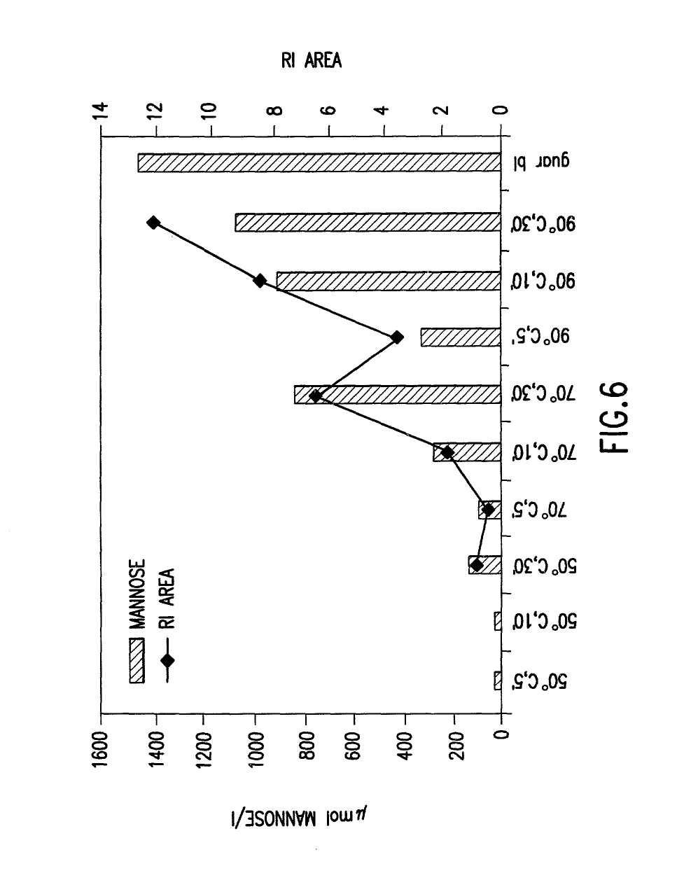

The results (% aldehyde), as determined by the reduction method described in Example 10, for Sample A and B are shown in FIG. 1 and FIG. 2, respectively. The SEC data for Sample A and B are shown in FIG. 3 and FIG. 4, respectively. FIG. 5 shows the product from the RI area with the % aldehyde groups in solution as a function of the blender time and temperature. FIG. 6 shows a comparison of the SEC analysis (as RI area) with the HPAEC analysis (Fmol mannose/L of Sample A) (This comparison was also made for Sample B, but due to the fact that more oxidized guar was dissolved in the sample, the sugar concentration was too high, and the mannose concentration fell out of the standard curve, resulting in an improper measurement.)

The results in FIGS. 1 and 2 show that the higher the temperature, the more guar is dissolved. However, from FIGS. 3 and 4, it is seen that almost no aldehyde groups are left at the higher temperature. Note that the pH of these samples is about 9.0. From the data in FIGS. 1 through 5, it is concluded that 30 minutes in a Warring Blender, at mixing position 6 (of 7), at 70° C., is most favorable. (It should be noted, however, that pH was not controlled in these experiments. The following example (Example 17) shows that controlling the pH results in a change in optimum operating conditions.) FIG. 6 shows that there is a good comparison between the time consuming HPAEC analysis and the SEC analysis when a concentration of 0.1% oxidized guar is used. However, SEC analysis on a 0.5% oxidized guar solution (dissolved at 70° C. in a blender for 30 minutes) showed a very low RI area. Thus, a sugar analysis is preferred at such high oxidized guar concentrations. To re-confirm the need for a relatively high shear mixer, a simple test was performed. In the simple test, an oxidized guar sample is dissolved using a Warring Blender, a mechanical stirrer, and a magnetic stirrer. Testing conditions are 30 minutes and 70° C. FIG. 7 shows the results of the test, which indicate that the Warring Blender dissolved the oxidized guar to a greater extent than either the mechanical stirrer or the magnetic stirrer.

Thus, from this example, it can be concluded that solubility of cationic oxidized guar is dependent on aldehyde content, temperature, pH, shear, and mixing time of the blender. It appears that, assuming that pH is allowed to vary, the optimal conditions for dissolving a 0.1% cationic oxidized guar sample having 30-35% aldehyde groups in tap water, prepared as 1% guar and 1% PEG is: 70° C., and using a blender for 30 minutes.

### Example 17

### Dissolution of Oxidized Guar with Variations in pH

This example is performed to determine the optimum conditions for dissolving cationic oxidized guar when pH is varied. In this example, the proper amount of cationic oxidized guar is added to tap water to obtain a 0.1% solution. The pH of the solution is then adjusted with a few drops of 1M HCl, while stirring on a magnetic stirrer. The pH-adjusted solution is poured into a Warring Blender which is kept at a temperature of 90° C. The mixing time is varied between 5 and 10 minutes. The sample used is prepared with 1% guar (N-Hance 3198) and 1% PEG 6000. The percent aldehyde groups in the dry product are measured with the reduction method as described in Example 10. After mixing, the samples are analyzed with SEC and the reduction method as described in Example 10. The RI area data that are generated with SEC are used as a measure for the dissolved cationic oxidized guar. The percent aldehyde groups after dissolution is measured with the reduction method as described in Example 10. FIG. 8 shows the RI areas for a 0.1% cationic oxidized guar sample having 35% aldehyde groups, dissolved in tap water, with various pH and mixing times, with a mixing temperature of 90° C. FIG. 9 shows the percent aldehyde groups of a 0.1% sample (with 35% aldehyde groups), dissolved in tap water, with various pH and mixing times, with a mixing temperature of 90° C. (The analysis of this sample dissolved at a pH of 6.3 and mixed for 10 minutes failed, so this data is not presented.) FIG. 10 shows the product of the RI area and the percent aldehyde groups, given at various pH and mixing times, with a mixing temperature of 90° C.

From this example, it can be concluded that acidifying the sample in tap water with a drop of acid seems to protect the aldehyde groups of the dissolved cationic oxidized guar during the mixing at high shear and temperature of 90° C. There is a dramatic decrease in the percent aldehyde groups on the dissolved cationic oxidized guar when the pH is greater than 7. There is also a large difference in the dissolution of the cationic oxidized guar between 5 minutes and 10 minutes mixing. Longer mixing time appears to dissolve more of the cationic oxidized guar without affecting the percent of aldehyde groups.

Thus, it appears that, when pH, temperature, and mixing time, are considered, the optimum conditions for dissolving cationic oxidized guar are: 1) dissolve the oxidized guar in tap water acidified to a pH of 5.4, 2) using a high shear and intensive turbulence blender (Warring Blender) at a temperature of 90° C., mix for 10 minutes.

### Example 18

### Measurement of Dissolved Guar by Size Exclusion Chromatography (SEC)

The SEC analyses were performed on a Hewlett Packard 1050 system with vacuum degasser. The system was equipped with a TSK-gel column set: PWXL guard, G2500PWXL and G3000PWXL (TOSOHAAS). The temperature of the column oven was 40° C. The eluent was a 0.1 M acetic acid (Merck) solution with the pH adjusted to 4.4 with sodium hydroxide (Baker, 7067). 100 μL sample was injected. Separation was performed at a flow rate of 0.8 mL/min. The compounds were detected by a 90 degrees laser light scattering detector (Viscotek model T 60A), a viscosity detector (Viscotek model T60A) and a Refractive Index detector (Hewlett Packard 1047A). The refractive index area of the oxidized guar peak was calculated by the Viscotek software and used as a relative number for the determination of the amount of polymer in solution. The areas were compared with the amount of mannose present in the sample.

### Example 19

### Measurement of Dissolved Guar by HPAEC-PAD

Mannose content in the filtrates was determined by using HPAEC-PAD in combination with methanolysis and TFA hydrolysis. 250 μl sample (filtrate) was pipetted into a screw-cap test tube and the sample was dried by N2 gas evaporation. The dried sample was first hydrolyzed by adding 0.5 ml of a 2 M methanolic HCl solution (Supelco, 3-3050) under nitrogen. The tubes were closed and incubated at 80° C. for 16 hours using an oil bath. After cooling, the samples were dried under a nitrogen gas flow. a second hydrolysis step was performed by adding 0.5 ml of a 2 M trifluor acetic acid solution (Acros, 13972-1000). The samples were heated to 121° C. and incubated for 1 hour. After cooling, the samples were evaporated to dryness using a nitrogen gas flow. The samples were dissolved in 200 μl acetate buffer (0.05 M sodium acetate, pH=5), put into a vial and subjected to HPAEC analysis. a calibration line of mannose (Acros, 15.060.0250) was made for quantification. Five different aliquots of a stock solution of 14.9 mg mannose (99%) in 200 ml water were subjected to the same hydrolysis steps as the samples. The volumes of the standard mannose solution were: 200, 100, 70, 40 and 10 μl corresponding to a final concentrations of 409.3, 204.7, 143.3, 81.9 and 20.5 3 mol/L of mannose, respectively. The HPAEC equipment consists of a GP40 gradient pump, an AS3500 autosampler and an ED40 electrochemical detector (PAD) with a gold electrode (Dionex, Breda, Netherlands). 20 μl of sample was injected at room temperature on a CarboPac PAl column (Dionex). Separation was performed with a flow rate of 1 mL/min using a combined gradient of three eluents prepared from milli Q water (Millipore). Eluent a: 0.1 M NaOH prepared from a 50% solution of NaOH (Baker, 7067). Eluent B: 0.1 M NaOH and IM sodium acetate (Merck, 1.06268.1000). Eluent C: milli Q water. The eluents were degassed by helium. The following gradient was applied for NaOH: 0-20 min, 20 mM NaOH; 20-35 min, 100 mM NaOH; 35-50 20 mM NaOH. The simultaneous gradient of NaAc was: 0-21 min, 0 M; 21-30 min, 0-300 mM; 30.01-35 min, 1000 mM NaAc; 35.01-50 min, 0 M.

The effluent was monitored using a pulsed-electrochemical detector in the pulsed amperometric mode (PAD) with a gold working electrode and an Ag/AgCl reference electrode (Dionex) to which potentials of E1 0.1 V, E2 0.65 V and E3 B0.1 V were applied for duration times of T1 0.4 s, T2 0.2 s, T3 0.4 s. Data collection was done with Peaknet software release 4.2 (Dionex).

From the amount of mannose, present in the sample, the amount of oxidized guar can be calculated if the ratio of galactose and mannose is known. Analysis of guar derivatives by the reduction method described in example 10 show that the ratio is close to 1:2.

### Example 20

### Investigation of Di(Ethylene Glycol) Monobuthyl Ether as Viscosity Reducing Agent

To 200 ml oxidized guar solution (1% cationic oxidized guar, N-Hance 3198, Hercules Incorporated, Wilmington, Delaware, 35% aldehyde) 10.4 g of di(ethylene glycol) monobutyl ether (Acros) were added under stirring with a mechanical stirrer. No reduction in viscosity or formation of a two-phase system could be observed after stirring over night.

The preceding examples can be repeated with similar success by substituting the generically and specifically described constituents and/or operating conditions of this invention for those used in the preceding examples. From the foregoing descriptions, one skilled in the art can easily ascertain the essential characteristics of this invention, and without departing from the spirit and scope thereof, can make various changes and modifications of the invention to adapt it to various usages and conditions.

What is claimed is:

1. A method for reducing viscosity in an aqueous polysaccahride composition comprising combining the aqueous composition with a non-aqueous viscosity reducing agent and wherein the water content of the composition is at least about 40 wt %.

2. The method of claim 1, wherein the polysaccahride comprises a carbohydrate gum.

3. The method of claim 2, wherein the water content of the composition is at least about 50 wt %.

4. The method of claim 2, wherein the water content of the composition is at least about 80 wt %.

5. The method of claim 2, wherein the water content of the composition is at least about 85 wt %.

6. The method of claim 2, wherein the carbohydrate gum comprises at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof.

7. The method of claim 6, wherein the carbohydrate gum comprises guar gum.

8. The method of claim 2, wherein the carbohydrate gum comprises oxidized carbohydrate gum.

9. The method of claim 8, wherein the oxidized carbohydrate gum comprises oxidized guar gum.

10. The method of claim 2, wherein the viscosity reducing agent comprises at least one member selected from the group comprising polyethylene glycols and mixtures thereof.

11. The method of claim 2, wherein the viscosity reducing agent comprises at least one polyethylene glycol.

12. The method of claim 11, wherein the at least one polyethylene glycol exhibits a molecular weight of from about 1,000 to about 50,000 daltons.

13. The method of claim 11, wherein the at least one polyethylene glycol exhibits a molecular weight of greater than about 1,000 daltons

14. The method of claim 2, wherein the viscosity of the aqueous composition is reduced by at least about 90% compared to the polysaccharide composition before combining the polysaccharide composition with the viscosity reducing agent.

15. The method of claim 2, wherein the viscosity of the aqueous composition is reduced by at least about 50% compared to the polysaccharide composition before combining the polysaccharide composition with the viscosity reducing agent.

16. The method of claim 2, wherein the viscosity of the aqueous composition is reduced by at least about 30% compared to the polysaccharide composition before combining the polysaccharide composition with the viscosity reducing agent.

17. The method of claim 2, wherein the viscosity of the aqueous composition is reduced by at least about 10% compared to the polysaccharide composition before combining the polysaccharide composition with the viscosity reducing agent.

18. A method for reducing viscosity of an aqueous composition of polysaccharide comprising combining viscosity reducing agent with the polysaccharide composition in an amount effective to form a two phase system comprising a continuous phase and a discontinuous phase.

19. The method of claim 18, wherein the polysaccharide comprises carbohydrate gum.

20. The method of claim 19, wherein the continuous phase is rich in viscosity reducing agent and the discontinuous phase is rich in polysaccharide.

21. The method of claim 19, wherein the viscosity of the aqueous composition is reduced by at least about 90% compared to the viscosity of the polysaccharide composition in the absence of the viscosity reducing agent.

22. The method of claim 19, wherein the viscosity of the aqueous composition is reduced by at least about 50% compared to the viscosity of the polysaccharide composition in the absence of the viscosity reducing agent.

23. The method of claim 19, wherein the viscosity of the aqueous composition is reduced by at least about 30% compared to the viscosity of the polysaccharide composition in the absence of the viscosity reducing agent.

24. The method of claim 19, wherein the viscosity of the aqueous composition is reduced by at least about 10% compared to the viscosity of the polysaccharide composition in the absence of the viscosity reducing agent.

25. The method of claim 19, wherein the polysaccharide is carbohydrate gum and the viscosity reducing agent comprises at least one polyethylene glycol.

26. The method of claim 25, wherein the at least one polyethylene glycol exhibits a molecular weight greater than about 1,000 daltons.

27. The method of claim 19, wherein the water content of the composition is at least about 40 wt %.

28. The method of claim 19, wherein the water content of the composition is at least about 50 wt %.

29. The meothd of claim 19, wherein the water content of the composition is at least about 80 wt %.

30. The method of claim 19, wherein the water content of the composition is at least about 85 wt %.

31. The method of claim 19, wherein the carbohydrate gum comprises at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof.

32. The method of claim 31, wherein the carbohydrate gum comprises guar gum.

33. The method of claim 19, wherein the carbohydrate gum comprises oxidized carbohydrate gum.

34. The method of claim 33, wherein the oxidized carbohydrate gum comprises oxidized guar gum.

35. The method of claim 19, wherein the viscosity reducing agent comprises at least one member selected from the group comprising polyethylene glycols, and mixtures thereof.

36. The method of claim 35, wherein the viscosity reducing agent comprises at least one polyethylene glycol.

37. The method of claim 36, wherein the at least one polyethylene glycol exhibits a molecular weight of greater than about 1,000 daltons.

38. A method for reducing viscosity of an aqueous composition of polysaccharide comprising combining said aqueous composition with an effective amount of non-aqueous viscosity reducing agent such that the viscosity of the polysaccharide composition is reduced by at least about 10% compared to the viscosity of the polysaccharide composition in the absence of the viscosity reducing agent.

39. The method of claim 38, wherein the polysaccharide comprises carbohydrate gum.

40. The method of claim 39, wherein the viscosity of the polysaccharide composition is reduced by at least about 30% compared to the viscosity of the polysaccharide composition in the absence of the viscosity reducing agent.

41. The method of claim 39, wherein the viscosity of the aqueous composition is reduced by at least about 50% compared to the viscosity of the polysaccharide composition in the absence of the viscosity reducing agent.

42. The method of claim 39, wherein the viscosity of the aqueous composition is reduced by at least about 90% compared to the viscosity of the polysaccharide composition in the absence of the viscosity reducing agent.

43. The method of claim 39, wherein the water content of the composition is at least about 40 wt %

44. The method of claim 39, wherein the water content of the composition is at least about 50 wt %.

45. The method of claim 39, wherein the water content of the composition is at least about 80 wt %.

46. The method of claim 39, wherein the water content of the composition is at least about 85 wt %.

47. The method of claim 39, wherein the carbohydrate gum comprises at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof.

48. The method of claim 47, wherein the carbohydrate gum comprises guar gum.

49. The method of claim 39, wherein the carbohydrate gum comprises oxidized carbohydrate gum.

50. The method of claim 49, wherein the oxidized carbohydrate gum comprises oxidized guar gum.

51. The method of claim 39, wherein the viscosity reducing agent comprises at least one member selected from the group comprising polyethylene glycols, and mixtures thereof.

52. The method of claim 39, wherein the viscosity reducing agent comprises at least one polyethylene glycol.

53. The method of claim 52, wherein the at least one polyethylene glycol exhibits a molecular weight of from about 1,000 to about 50,000 daltons.

54. The method of claim 52, wherein the at least one polyethylene glycol exhibits a molecular weight of greater than about 1,000 daltons.

55. An aqueous composition comprising polysaccharide and non-aqueous viscosity reducing agent, and wherein the water content of the composition is at least about 40 wt %.

56. The composition of claim 55, wherein the polysaccharide comprises carbohydrate gum.

57. The composition of claim 56, wherein the water content of the composition is at least about 50 wt %.

58. The composition of claim 56, wherein the water content of the composition is at least about 80 wt %.

59. The composition of claim 56, wherein the water content of the composition is at least about 85 wt %.

60. The composition of claim 56, wherein the carbohydrate gum comprises at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof.

61. The composition of claim 60, wherein the carbohydrate gum comprises guar gum.

62. The composition of claim 61, wherein the carbohydrate gum comprises oxidized-carbohydrate gum.

63. The composition of claim 62, wherein the oxidized carbohydrate gum comprises oxidized guar gum.

64. The composition of claim 56, wherein the viscosity reducing agent comprises at least one member selected from the group comprising polyethylene glycols, and mixtures thereof.

65. The composition of claim 56, wherein the viscosity reducing agent comprises at least one polyethylene glycol.

66. The composition of claim 65, wherein the at least one polyethylene glycol exhibits a molecular weight of from about 1,000 to about 50,000 daltons.

67. The composition of claim 65, wherein the at least one polyethylene glycol exhibits a molecular weight of greater than about 1,000 daltons

68. The composition of claim 65, further comprising a component capable of oxidizing carbohydrate gum.

69. The composition of claim 56, wherein the viscosity of the aqueous composition is reduced by at least about 90% compared to the viscosity of the polysaccharide composition in the absence of the viscosity reducing agent.

70. The composition of claim 56, wherein the viscosity of the aqueous composition is reduced by at least about 50% compared to the viscosity of the polysaccharide composition in the absence of the viscosity reducing agent.

71. The composition of claim 56, wherein the viscosity of the aqueous composition is reduced by at least about 30% compared to the viscosity of the polysaccharide composition in the absence of the viscosity reducing agent.

72. The composition of claim 56, wherein the viscosity of the aqueous composition is reduced by at least about 10% compared to the viscosity of the polysaccharide composition in the absence of the viscosity reducing agent.

73. A composition comprising polysaccharide, aqueous solvent and viscosity reducing agent, and wherein the aqueous polysaccharide composition is combined with an effective amount of viscosity reducing agent such that a two phase system comprising a continuous phase and a discontinuous phase is formed.

74. The composition of claim 73, wherein the polysaccharide comprises carbohydrate gum.

75. The composition of claim 74, wherein the continuous phase is rich in viscosity reducing agent and the discontinuous phase is rich in polysaccharide.

76. The composition of claim 74, wherein the viscosity of the aqueous composition is reduced by at least about 90% compared to the viscosity of the polysaccharide composition in the absence of the viscosity reducing agent.

77. The composition of claim 74, wherein the viscosity of the aqueous composition is reduced by at least about 50% compared to the viscosity of the polysaccharide composition in the absence of the viscosity reducing agent.

78. The composition of claim 74, wherein the viscosity of the aqueous composition is reduced by at least about 30% compared to the viscosity of the polysaccharide composition in the absence of the viscosity reducing agent.

79. The composition of claim 74, wherein the viscosity of the aqueous composition is reduced by at least about 10% compared to the viscosity of the polysaccharide composition in the absence of the viscosity reducing agent.

80. The composition of claim 74, wherein the polysaccharide is carbohydrate gum and the viscosity reducing agent comprises at least one polyethylene glycol.

81. The composition of claim 80 wherein the at least one polyethylene glycol exhibits a molecular weight greater than about 1,000 daltons.

82. The composition of claim 74, wherein the water content of the composition is at least about 40 wt %.

83. The composition of claim 74, wherein the water content of the composition is at least about 50 wt %.

84. The composition of claim 74, wherein the water content of the composition is at least about 80 wt %.

85. The composition of claim 74, wherein the water content of the composition is at least about 85 wt %.

86. The composition of claim 74, wherein the carbohydrate gum comprises at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof.

87. The composition of claim 86, wherein the carbohydrate gum comprises guar gum.

88. The composition of claim 74, wherein the carbohydrate gum comprises oxidized carbohydrate gum.

89. The composition of claim 88, wherein the oxidized carbohydrate gum comprises oxidized guar gum.

90. The composition of claim 74, wherein the viscosity reducing agent comprises at least one member selected from the group comprising polyethylene glycols, and mixtures thereof.

91. The composition of claim 90, wherein the viscosity reducing agent comprises at least one polyethylene glycol.

92. The composition of claim 91, wherein the at least one polyethylene glycol exhibits a molecular weight of greater than about 1,000 daltons.

93. The composition of claim 91, wherein the at least one polyethylene glycol exhibits a molecular weight of from about 200 to about 8,000,000 daltons.

94. A composition for reducing viscosity of an aqueous composition of polysaccharide comprising combining an effective amount of non-aqueous viscosity reducing agent such that the viscosity of the polysaccharide composition is reduced by at least about 10% compared to the viscosity of the polysaccharide composition in the absence of the viscosity reducing agent.

95. The composition of claim 94, wherein the polysaccharide comprises carbohydrate gum.

96. The composition of claim 95, wherein the viscosity of the aqueous composition is reduced by at least about 30% compared to the viscosity of the polysaccharide composition in the absence of the viscosity reducing agent.

97. The composition of claim 95, wherein the viscosity of the aqueous composition is reduced by at least about 50% compared to the viscosity of the polysaccharide composition in the absence of the viscosity reducing agent.

98. The composition of claim 95, wherein the viscosity of the aqueous composition is reduced by at least about 90% compared to the viscosity of the polysaccharide composition in the absence of the viscosity reducing agent.

99. The composition of claim 95, wherein the polysaccharide is carbohydrate gum and the viscosity reducing agent comprises at least one polyethylene glycol.

100. The composition of claim 95, wherein the at least one polyethylene glycol exhibits a molecular weight greater than about 1,000 daltons.

101. The composition of claim 95, wherein the at least one polyethylene glycol exhibits a molecular weight of from about 200 to about 8,000,000 daltons.

102. The composition of claim 95, wherein the water content of the composition is at least about 40 wt %.

103. The composition of claim 95, wherein the water content of the composition is at least about 50 wt %.

104. The composition of claim 95, wherein the water content of the composition is at least about 80 wt %.

105. The composition of claim 95, wherein the water content of the composition is at least about 85 wt %.

106. The composition of claim 95, wherein the carbohydrate gum comprises at least one member selected from the group comprising agar, guar gum, xanthan gum, gum arabic, pectin, carboxymethyl cellulose, ethyl cellulose, methyl cellulose, hydroxypropylmethyl cellulose, hydroxypropyl cellulose and mixtures thereof.

107. The composition of claim 106, wherein the carbohydrate gum comprises guar gum.

108. The composition of claim 107, wherein the carbohydrate gum comprises oxidized carbohydrate gum.

109. The composition of claim 108, wherein the oxidized carbohydrate gum comprises oxidized guar gum.

110. The composition of claim 109, wherein the viscosity reducing agent comprises at least one member selected from the group comprising polyethylene glycols, and mixtures thereof.

111. The composition of claim 110, wherein the viscosity reducing agent comprises at least one polyethylene glycol.

112. The composition of claim 111, wherein the at least one polyethylene glycol exhibits a molecular weight of greater than about 1,000 daltons.

113. A method of oxidizing carbohydrate gum comprising combining carbohydrate gum, aqueous solvent, non-aqueous viscosity reducing agent and an oxidizing component under conditions effective to oxidize the carbohydrate gum.

114. The method of claim 113, wherein the oxidizing component comprises a member selected from the group consisting of potassium dichromate, potassium permanganate, and mixtures thereof.

115. The method of claim 113, wherein the oxidizing component comprises a metal catalyst and hydrogen peroxide.

116. The method of claim 113, wherein the oxidizing component comprises galactose oxidase.

117. The method of claim 113, wherein the composition further comprises catalase.

118. A method of resolubilizing solid oxidized carbohydrate gum comprising combining aqueous solvent with the oxidized carbohydrate gum under conditions effective to give a resolubilized composition a pH less than about 7.

119. The method of 118, wherein the solid oxidized carbohydrate gum has a water content of less than 60%.

120. The method of claim 118, wherein the resolubilized composition has a pH less than about 6.

121. The method of claim 118, wherein the resolubilized composition has a pH less than about 5.

122. The method of claim 118, wherein the resolubilized composition has a pH of about 5.4.

123. The method of claim 118, wherein the resolubilized composition has a pH in the range of about 4 to about 7.

124. The method of claim 118, further comprising heating the combined solid oxidized carbohydrate gum and aqueous solvent.

125. The method of claim 124, wherein the resulting temperature of the resolubilized composition is 90° C.

126. The method of claim 124, wherein the resulting temperature of the resolubilized composition is greater than about 80° C.

127. The method of claim 124, wherein the resulting temperature of the resolubilized composition is within the range of about 65° C. to about 115° C.

128. The method of claim 118, further comprising adding shear effective to create turbulence in the combined solid oxidized carbohydrate gum and aqueous solvent.

129. The method of claim 118, further comprising simultaneously adding shear and heating the combined solid oxidized carbohydrate gum and aqueous solvent.

130. The method of claim 129, wherein the resulting temperature of the resolubilized composition is 90° C. and the pH is less than about 6.

131. The method of claim 118, wherein the aldehyde content of the resolubilized oxidized carbohydrate gum includes at least approximately 70% of the aldehyde content of the oxidized carbohydrate gum.

132. The method of claim 118, wherein the aldehyde content of the resolubilized oxidized carbohydrate gum includes at least approximately 80% of the aldehyde content of the oxidized carbohydrate gum.

133. The method of claim 118, wherein the aldehyde content of the resolubilized oxidized carbohydrate gum includes at least approximately 90% of the aldehyde content of the oxidized carbohydrate gum.

134. The method of claim 118, wherein the aldehyde content of the resolubilized oxidized carbohydrate gum is substantially the same as the aldehyde content of the oxidized carbohydrate gum.

135. The method of claim 118, wherein the carbohydrate gum comprises oxidized guar.

136. The method of claim 118, wherein the resulting aqueous composition has a viscosity that is low enough for the composition to be pumpable.

137. The method of claim 118, wherein the concentration of oxidized guar in the resulting solution is less than 10% w/v.

138. The method of claim 118, wherein the concentration of oxidized guar in the resulting solution is less than 5% (w/v).

139. The method of claim 118, wherein the concentration of oxidized guar in the resulting solution is less than 1.5% (w/v).
